(19) United States
(12) Patent Application Publication
(10) Pub. No.: US 2013/0026409 A1
(43) Pub. Date: Jan. 31, 2013

(54) Composite ionic conducting electrolytes

(71) Applicants: Amanda Baker, Boalsburg, PA (US); Niall J. Donnelly, San Mateo, CA (US); Enkhtuvshin Dorjpalam, Port Matilda, PA (US); Soonil Lee, State College, PA (US); Mehdi Mirsaneh, State College, PA (US); Weiguo Qu, State College, PA (US); Ramakrishnan Rajagopalan, State College, PA (US); Clive A. Randall, State College, PA (US); Aram Yang, Berkeley, CA (US)

(72) Inventors: Amanda Baker, Boalsburg, PA (US); Niall J. Donnelly, San Mateo, CA (US); Enkhtuvshin Dorjpalam, Port Matilda, PA (US); Soonil Lee, State College, PA (US); Mehdi Mirsaneh, State College, PA (US); Weiguo Qu, State College, PA (US); Ramakrishnan Rajagopalan, State College, PA (US); Clive A. Randall, State College, PA (US); Aram Yang, Berkeley, CA (US)

(73) Assignees: Recapping, Inc., Menlo Park, CA (US); The Penn State Research Foundation, University Park, PA (US)

(21) Appl. No.: 13/506,239

(22) Filed: Apr. 5, 2012

Related U.S. Application Data
(60) Provisional application No. 61/516,928, filed on Apr. 8, 2011.
(60) Provisional application No. 61/479,357, filed on Apr. 26, 2011.
(60) Provisional application No. 61/626,821, filed on Oct. 3, 2011.

(51) Int. Cl. H01G 9/025; G02F 1/153; H01M 12/06; H01M 10/0562; H01M 8/10

(52) U.S. Cl. 252/62.2; 429/309; 429/492; 429/479; 429/405; 429/304; 361/525; 359/265

(57) ABSTRACT

Ionically conducting, redox active additive composite electrolytes are disclosed. The electrolytes include an ionically conductive component and a redox active additive. The ionically conductive component may be an ionically conductive material such as an ionically conductive polymer, ionically conducting glass-ceramic, ionically conductive ceramic, and mixtures thereof. Electrical energy storage devices that employ the ionically conducting, redox active additive composite electrolytes also are disclosed

### STATEMENT OF GOVERNMENT INTERESTS

This invention was made with government support under Advanced Research Projects Agency-Energy Contract No. DE-AR0000070. The government has certain rights in the invention.

### BACKGROUND OF THE INVENTION

Modern electrochemical energy storage devices such as lithium ion batteries and electrochemical double layer capacitors (EDLC) include an anode and a cathode that are separated by an electrolyte. The electrolyte functions to enable passage of ionic carriers between the anode and cathode and is electrochemically stable within the operating voltage range. The electrolyte also functions as an electrical insulator to prevent short-circuiting between the anode and the cathode. These requirements have been met in the art by use of a porous polymer membrane soaked in a solution of an ionically conducting electrolyte.

In lithium ion batteries, a Li+ and PF₆ conducting electrolyte solution of LiPF₆ in (EC) solvent and/or (DMC) solvent have been employed. This type of Li+ conducting electrolyte offers greater voltage stability vs. Li compared to aqueous systems. The conductivity of this type of Li+ conducting electrolyte, however, is often several orders lower than that of aqueous systems.

An ionically conducting electrolyte also may be formed from a single-phase material such as an ionically conducting polymer. A limiting factor in selection of an ionically conducting electrolyte for use in an energy storage/generation device is electrolyte conductivity. Low electrolyte conductivity adds internal electrical resistance to the device and reduces peak power output.

In energy storage devices such as capacitors that employ a Li+ electrolyte, peak operational voltage to which the device can be charged is limited by decomposition of the electrolyte and/or reactions between the electrolyte and carbon electrodes. Currently, the achievable volumetric energy density of capacitive energy storage devices is about 100 times less than that of batteries.

A need therefor exists for improving the volumetric energy densities of energy storage devices such as capacitive devices.

### BRIEF DESCRIPTION OF THE DRAWINGS

FIGS. 1A, 1B show top and side views of a hybrid battery capacitor having a multi-sectional cathode;

FIGS. 2 to 10 show electrode configurations that may be utilized in a hybrid battery capacitor;

FIG. 11 shows a multilayer configuration for the hybrid battery-capacitor;

FIG. 12 shows charge behavior of a Li-ion capacitors;

FIG. 13 shows a cylindrical Li-ion hybrid composite membrane;

FIG. 14 shows a device where a unfilled air spaces are present between a membrane and an electrode;

FIGS. 15-21 show tapes having differing morphologies of redox active additives in membranes;

FIG. 22 shows a Li-air battery that utilizes a ceramic membrane.

FIG. 23 effects of redox active electrolyte on constant current discharge of a capacitor;

FIG. 24 shows effects of redox active electrolyte on cycling stability;

FIG. 25 shows effects of redox active electrolyte on charge-discharge behavior.

### SUMMARY OF THE INVENTION

The disclosed invention relates to ionically conducting, redox active additive composite electrolytes and to devices such as energy storage devices that employ those electrolytes. An electrode employed in these types of devices may function to exchange an ionic carrier in the electrolyte and another electrode in these types of devices may function as ionically blocking or redox active. The ionically conducting, redox active additive composite electrolyte may employ an ionically conductive component and a redox active additive wherein the ionically conductive component is any one or more of ionically conductive polymer, ionically conducting glass-ceramic, ionically conductive ceramic, and mixtures thereof.

In one aspect, the invention relates to ionically conducting polymer, redox active additive composite electrolytes. In a second aspect, the invention relates to ionically conducting glass-ceramic, redox active additive composite electrolytes. In a third aspect, the invention relates to ionically conducting ceramic, redox active additive composite electrolytes. In a fourth aspect, the invention relates to electrical energy storage/generation devices that employ ionically conducting, redox active additive composite electrolytes.

Ionically conducting composite electrolytes that include any one or more of ionically conducting polymer and redox active additives, ionically conducting glass and redox active additives, ionically conducting glass-ceramic and redox active additives, ionically conducting ceramic and redox active additives, and ionically conducting gel and redox active additives may achieve higher voltage operational stability and use of greater volumes of the electrolyte to store energy.

The ionically conducting composite electrolytes may be used in a variety of energy storage/generation devices such as capacitive and battery energy storage, electrochemical devices such as fuel cells, electrochromic devices and gas sensors. The ionically conducting composite electrolytes also may be employed in catalysis and as gas separation membranes.

### DETAILED DESCRIPTION OF THE INVENTION

The following terms as used herein below are understood to have to following meanings:

CTFE: chlorotrifluoroethylene

HFP: hexafluoropropylene

DMC: dimethyl carbonate

EC: ethylene carbonate

HFP: hexafluoropropylene

LAGP: lithium aluminum germanium phosphate

LiTf: lithium trifluoromethane

LIBETI: LiNC₂F₅(SO₂)₂

LiBOB: Li bis(oxalato)borate

LiTFSI: lithium trifluoromethanesulfonimide

MBL: alpha-methylene gamma-butyrolactone

MEEP: poly[bis((methoxyethoxy)ethoxy)phosphazene

MEK: methyl ethyl ketone

Nafion: tetrafluoroethylene-perfluoro-3,6-dioxa-4-methyl-7-octenesulfonic acid copolymer

PAEOA: poly(acetyl-oligo(ethylene oxide)acrylate)

PBI: polybenzimidazole

PDE: poly(ethylene glycol)dimethacrylate

PEEK: polyether ether ketone

PEDA: polyester diacrylate

PEDOT: (Poly(3,4-ethylenedioxythiophene)

PEG: poly(ethylene glycol)

PEGMA: poly(ethylene glycol)methyl ether methacrylate

PEO: poly(ethylene oxide)

PEOMA: poly(ethylene oxide)methyl ether methacrylate

PES: polyethersulfone

PME: poly(ethylene glycol)methacrylate

PPI: Poly(propylene imine)

PPO: Poly(propylene oxide)

PS: Poly(sulfone)

PVA: Poly(vinyl alcohol)

PVDF: polyvinylidene fluoride

SMA: stearylmethacyrlate

TEGDA: tri(ethylene glycol)diacrylate

TFE: Tetrafluoroethylene

TrFE: trifluoroethylene

Ionically conducting polymer composite electrolytes having one or more of redox active inclusions, redox active phases and mixtures thereof and one or more ionically conducting polymers are disclosed.

Generally, ionically conducting polymer, redox active additive composite electrolytes may be made by admixing an ionically conducting polymer solution with a redox active additive. Alternatively, a non-conducting polymer that includes a redox additive may be treated with an ionic conducting solution of a desired metal to impart ionic conductivity to the polymer to produce an ionically conducting polymer, redox active additive composite electrolyte.

Polymers that may be employed in a solution of ionically conductive polymer include but are not limited to fluoropolymers and copolymers such as but are not limited to PVDF, PVDF-HFP, PVDF-TFE, PVDF-CTFE, PVDF-TrFE mixtures thereof. Other polymers that may be employed include but are not limited to ethylene oxide such as PEO, PEOMA, PAEOA, PEG, PEDAO-PEG copolymers, PDE, PME, PEGMA, TEGDA, poly(dimethyl siloxane), poly(oxymethylene[oxyethylene]). MEEP, copolymers such as PEOMA-MBL, PAEOA, PEDA-PEG, PME-SMA, PDE-PME-PEG, PS-PEGMA, PPI, PS-PDVP, polystyrene block copolymers, random copolymers such as poly(dioxolane), polysiloxanes, polyphosphazenes such as but not limited to poly(dichlorophosphazene), PVA, PPO and mixtures thereof.

Solvents that may be employed in ionically conductive polymer solutions include but are not limited to aprotic type solvents such as DMAc, NMP, DMF and mixtures thereof. Where DMF is employed, the amount of polymer that may be dissolved in DMF may be about 1 wt. % to about 50 wt. %, preferably about 5 wt. % to about 40 wt. %, more preferably about 10 wt. % to about 30 wt. %, all amounts based on weight of polymer.

A wide variety of ionically conducting polymer solutions may be employed in manufacture of ionically conductive polymer, redox additive composite electrolytes. The ionically conducting polymer solutions may be made by treating a solvent solution of polymer with an ionic salt. Ionically conducting polymer solutions that may be employed in an ionically conducting polymer-redox active additive composite electrolyte include but are not limited to Ag⁺ conducting polymer solutions, H⁺ conducting polymer solutions, OH— conducting polymer solutions, Li⁺ conducting polymer solutions, Mg⁺ conducting polymer solutions, Na⁺ conducting polymer solutions, O⁻ conducting polymer solutions and mixtures thereof.

Ag⁺ conducting polymer solutions that may be employed include Ag⁺ conductive polymeric solutions of polymers such as but are not limited to PEO, PVDF, PVDF-HFP, PBI and mixtures thereof. Ag⁺ conducting polymer solutions may be formed by admixing an Ag⁺ salt such as but not limited to AgI, AgCl, AgNO₃ and mixtures thereof with a polymeric solution of Ag⁺ conductive polymer and an aprotic type solvent such as but not limited to EC, DMC and mixtures thereof.

H+ conducting polymer solutions that may be employed include H⁺ conductive polymeric solutions of polymers such as but are not limited to PEO, PBI, Nafion, PEEK, PES and mixtures thereof. H⁺ conducting polymer solutions may be formed by admixing a protonic acid such as but not limited to H₃PO₄, H₂SO₄ and mixtures thereof with a polymeric solution of H+ conductive polymer and an aprotic type solvent such as but not limited to EC, DMC and mixtures thereof.

OH— conducting polymer solutions that may be employed include OH— conductive polymeric solutions of polymers such as but are not limited to PEO, PBI, Nafion, PEEK, PES and mixtures thereof. OH— conducting polymer solutions may be formed by admixing a OH— salt such as but not limited to NaOH, KOH, and mixtures thereof with a polymeric solution of OH— conductive polymer and an aprotic type solvent such as but not limited to EC, DMC and mixtures thereof.

Li+ conducting polymer solutions that may be employed include Li+ conductive polymeric materials such as but are not limited to PEO, PVDF-HFP, PVDF-TFE, LiTf LiTFSI, LIBETI, LiClO₄, LiBOB, LiPF₆, LiBF₄ and mixtures thereof. Li⁺ conducting polymer solutions may be formed by admixing a Li+ salt such as but not limited to LiTf; LiTFSI, LIBETI, LiClO₄, LiBOB, LiPF₆, LiBF₄ and mixtures thereof with a polymeric solution of Li+ conductive polymer and an aprotic type solvent such as but not limited to EC, DMC and mixtures thereof. Preferably, a solution of LiPF₆ in a 1:1 mixture of EC:DMC by w/w may be employed. In this aspect, the concentration of LiPF₆ in the 1:1 mixture of EC:DMC may vary from about 0.5M to about 1.2M, preferably about 0.8M to about 1M.

Mg+ conducting polymer solutions that may be employed include Mg+ conductive polymeric solutions of polymers such as but are not limited to PEO, PVDF-HFP, PBI, PEEK, PES and mixtures thereof. Mg⁺ conducting polymer solutions may be formed by admixing a Mg+ salt such as but not limited to MgCl₂, Mg(ClO₄)₂ and mixtures thereof with a polymeric solution of Mg+ conductive polymer and an aprotic type solvent such as but not limited to EC, DMC and mixtures thereof.

Na+ conducting polymer solutions that may be employed include Na+ conductive polymeric solutions of polymers such as but are not limited to PEO, PVDF-HFP, PBI, PEEK, PES and mixtures thereof. Na⁺ conducting polymer solutions may be formed by admixing an Na+ salt such as but not limited to NaI, NaCl, NaNO3 and mixtures thereof with a polymeric solution of Na+ conductive polymer and an aprotic type solvent such as but not limited to EC, DMC and mixtures thereof. Where Na⁺ conducting polymer solutions are employed in a composite electrolyte, the electrode active material may be Na metal or a non-stoichiometric Na-oxide compound that enables Na+ exchange into the electrolyte.

Redox active additives may be incorporated in the ionically conductive polymer in various forms such as in the form of precursors of the redox active additive, solutions of redox active additives and particles of redox active additives. Redox active additives that may be employed in the solution of ionically conductive polymer may vary in accordance with the ionically conductive polymer employed. Where the redox active additives are employed in the form of particles, the particles may have a size of about 5 nm to about 100 μm, preferably about 10 nm to about 100 nm.

Where Ag+ conducting polymeric solutions are employed in manufacture of Ag+ conductive polymer-redox active composite electrolytes, redox active additives may include but are not limited to metals such as Cu, Pd, Bi, Sn that may alloy with Ag at potentials less than about −0.8V vs. SCE (Saturated calomel electrode). Where H⁺ conducting polymers are employed, the redox active additives include but are not limited to metal oxides that have a potential of about 1V vs. SCE. (Saturated calomel electrode).

Where Mg⁺ conducting polymers are employed, the redox active additives may include but are not limited to TiS₂, V₆O₁₃ and chromium oxides. Where Na⁺ conducting polymers are employed, the redox active additives include but are not limited to TiS₂, V₆O₁₃ and chromium oxides.

Where Li+ conducting polymeric solutions are employed in manufacture of Li+ conductive polymer-redox active composite electrolytes, redox active additives may include but are not limited to anode type metal oxides that have potential of about 2V or less vs. redox potential of lithium, cathode type metal oxide particles that have potential of about 2V or more vs. redox potential of lithium, metal particles that have an alloying potential of about 2V or more vs. Li/Li, mixtures of cathode type metal oxides and metal particles, mixtures of anode type metal oxides and metal particles, and mixtures of cathode type oxides with anode type oxides. Redox active oxides that have a low redox potential of about 2V or less vs. Li/Li that may be employed in Li⁺ conducting polymers include but are not limited to MoO₃, SnO₂, WO₃, PbO, ZnO, Fe₂O₃, Cr₂O₃, V₂O₅, MnO₂, Li₄Ti₅O₁₂, Li4+xTi₅O₁₂ and mixtures thereof. Redox active oxides that have a high redox potential of about 2V or more vs. Li/Li that may be employed include but are not limited to LiMn₂O₄, LiCoO₂, LiNiO₂, LiFeO₂, Liₓ(Co_{y}Al_{1-y})₍₁₋ₓ₎O₂ where 0<x<1, 0<y<1 and mixtures thereof.

High redox oxides, low redox oxides and mixtures thereof may be added to a solution of a Li+ ionically conductive polymer in an amount of about 0.5 wt. % to about 30 wt. %, preferably about 1 wt. % to about 10 wt. %, based on the weight of the Li+ ionically conductive polymer solution. Where MoO₃ is employed as a redox active additive, MoO₃ may be present in the a solution of Li⁺ conducting polymer in an amount of about 1 wt. % to about 30 wt. %, preferably about 1 wt. % to about 10 wt. %, all amounts based on the weight of the polymer solution.

Redox active metals that may be employed as redox additives in Li⁺ conducting polymer solutions include but not limited to Pt, Au, Sn, Pb, Zn, Si mixtures thereof and alloys thereof. Where Au particles are employed, the particles may vary in size from about 1 nm to about 200 nm. Redox active metals may be present in a solution of Li⁺ conducting polymer in an amount of about 0.1 wt. % to about 10 wt. %, preferably about 1 wt. % to about 5 wt. %, based on the weight of the polymer solution.

Manufacture of Products that Include Ionically Conducting Polymer, Redox Active Additive Composite Electrolytes

Ionically conducting polymer, redox active additive composite electrolytes may be cast into various products such as membranes by methods such as spin coating, thin film sputtering, aerosol spray, aerosol particle deposition, electrophoretic deposition, tape casting, screen-printing, and doctor blading. Where doctor blading is employed, the composite electrolytes may be doctor bladed onto a moving substrate such as a glass substrate or polymer substrate to form a cast sheet such as a membrane sheet of a composite electrolyte.

The thickness of a cast membrane sheet of a composite electrolyte may be varied by control of the solvent content of the slurry, the speed of the moving substrate and the width of the doctor blade opening. The thickness of the membrane sheet thus may vary over a wide range. Typically, the cast membrane sheets have a thickness of about 1 μm to about 450 μm, preferably about 10 μm to about 100 μm. The cast membrane sheets are dried on the substrate and then subjected to phase inversion by contacting with a lower alkanol such as but not limited to ethanol, methanol, isopropanol, and mixtures thereof, preferably ethanol. After phase inversion, the cast membrane sheets are removed from the glass substrate and again treated with a lower alkanol such as but not limited to ethanol, methanol, isopropanol and mixtures thereof, preferably ethanol for about 1 hr to about 16 hrs at about 20° C. to about 50° C. The treated membranes are dried such as by vacuum drying at about 20° C. to about 60° C., preferably about 20° C. to about 40° C. Typically, drying is performed at a temperature and for a time sufficient to achieve moisture content of <1%. The dried membrane sheets then are immersed in an ionic conducting solution in order to swell the polymer. Swelling can be enhanced by heating the membrane in the ionic conducting solution to about 55° C. for about 2 hrs to about 4 hrs.

Preparation of Separator Membranes Formed of Ionically Conducting Polymer, Redox Active Metal Oxide Composite Electrolyte

### Example P1

### Li+ Conducting PVDF-HFP Polymer, MoO₃ Composite Electrolyte Separator Membrane

2 gm. of PVDF-HFP reagent grade granules from Aldrich, MW: 400,000 g/mol are dissolved in 19 ml reagent grade DMF at 20° C. to produce a polymer solution. 10 gms of the polymer solution are mixed with 0.05 gm. MoO₃ redox active particles that have an average size of 100 nm to form a blend.

The MoO₃ particles are made by dissolving 0.8467 gms H₂MoO₄ in 2M ammonia solution to yield a 5 mM solution of H₂MoO₄. The pH of the solution is adjusted to a pH of 2-3 by dropwise addition of 4M HCl.

Additional 4M HCl is added under continuous stirring to form a white precipitate. The precipitate is collected by centrifuge and rinsed with absolute ethanol to form rinsed precipitate. Then, 0.8 gms of the rinsed precipitate is dispersed in 15 ml of absolute ethanol and heated at 150° C. for 8 hours to yield treated precipitate.

The treated precipitate is further washed with absolute ethanol and dried at 80° C. for 16 hrs to yield dried precipitate. The dried precipitate is heated at 5° C./min to 350° C., maintained at 350° C. for 5 h and then cooled to yield α-MoO₃. The blend of redox active MoO₃ particle and polymer solution is subjected to ultrasonic vibration for 20 min to produce a treated blend. The treated blend is doctor bladed onto a glass substrate to produce a cast membrane sheet of 25 μm thickness.

The cast membrane sheet is dried for 1 hour (ambient condition). The dried sheet then is subjected to phase inversion by contacting the sheet with absolute ethanol for 5 min. The resulting treated membrane sheet is removed from the substrate and immersed in absolute ethanol for 16 hrs and vacuum dried at 20° C. to form a dried membrane of PVDF-HFP having MoO₃ particles therein.

The dried membrane is immersed in a Li+ conducting polymer solution formed by dissolving 0.46 gms LiPF₆ in a 1:1 mixture by wt. of EC:DMC. The membrane is immersed in the Li+ conducting solution for 2 days to yield a Li+ conducting PVDF-HFP polymer, MoO₃ composite electrolyte separator membrane.

### Example P2

### Li+ Conducting PVDF-HFP Polymer, SnO₂ Composite Electrolyte Separator Membrane

The procedure of example P1 is followed except that 0.05 gms of SnO₂ is substituted for MoO₃ to yield a membrane having thickness of 240 μm SnO₂ is available from Aldrich.

### Example P3

### Li+ Conducting PVDF-HFP Polymer, WO₃ Composite Electrolyte Separator Membrane

2 gm. of PVDF-HFP reagent grade granules from Aldrich, MW: 400,000 g/mol are dissolved in 19 ml reagent grade DMF at 20° C. to enable formation of polymer solution. 10 gms of polymer solution are mixed with 0.05 gm. WO₃ redox active particles that have an average size of 100 nm to form a blend.

The blend of redox active WO₃ particle and polymer solution is ultrasonically vibrated for 20 min to enable formation of a treated blend. The treated blend is doctor bladed onto a glass substrate in order to form a cast membrane sheet. The cast membrane sheet is dried for 1 hour (ambient condition), contacted with absolute ethanol for 5 min, removed from the substrate, immersed in absolute ethanol for 16 hrs, vacuum dried at 20° C. and immersed in a Li⁺ conducting polymer solution formed by dissolving 0.46 gms LiPF₆ in a 1:1 mixture by wt. of EC:DMC for 2 days.

### Example P4

### Li+ Conducting PVDF-HFP Polymer, PbO Composite Electrolyte Separator Membrane

The procedure of example P3 is followed except that 0.05 gms of PbO is substituted for WO₃. PbO is available from Aldrich.

### Example P5

### Li+ Conducting PVDF-HFP Polymer, ZnO Composite Electrolyte Separator Membrane

The procedure of example P3 is followed except that 0.05 gms of ZnO is substituted for WO₃. ZnO is available from Aldrich.

### Example P6

### Li+ Conducting PVDF-HFP Polymer, Li₁₋ₓMn₂O₄ Composite Electrolyte Separator Membrane

The procedure of example P3 is followed except that 0.05 gms of Li₁₋ₓMn₂O₄ is substituted for WO₃. Li₁₋ₓMn₂O₄ is available from Aldrich.

### Example P6A

### Li+ Conducting PVDF-HFP Polymer, LiMn₂O₄ Composite Electrolyte Separator Membrane

The procedure of example P3 is followed except that 0.05 gms of LiMn₂O₄ is substituted for WO₃. LiMn₂O₄ is available from Aldrich.

### Example P7

### Li+ Conducting PVDF-HFP Polymer, LiₓCoO₂ Composite Electrolyte Separator Membrane

The procedure of example P3 is followed except that 0.05 gms of LiₓCoO₂ is substituted for WO₃. LiₓCoO₂ is available from Aldrich.

### Example P7A

### Li+ Conducting PVDF-HFP Polymer, LiCoO₂ Composite Electrolyte Separator Membrane

The procedure of example P3 is followed except that 0.05 gms of LiCoO₂ is substituted for WO₃. LiCoO₂ is available from Aldrich.

### Example P8

### Li+ Conducting PVDF-HFP Polymer MoO₃ Composite Electrolyte

2 gms of Li+ conducting PVDF polymer is dissolved in 19 ml of DMF solvent together with 0.46 gms of LiPF₆ to form a Li+ conducting polymer solution. To this solution, 0.05 gms of MoO₃ that have an average size of 100 nm are added. The resulting mixture is cast as a membrane using the procedure of example P1 and dried to constant weight at 20° C. to form a Li+ conducting polymer-MoO₃ composite electrolyte.

Preparation of Separator Membranes Formed of Ionically Conducting Polymer, Redox Active Metal Additive Composite Electrolyte

A metal precursor such as a metal acetylacetonate, metal alkoxide, medium/long chain carboxylic acid metal salts, chlorometallic acids such as HPtCl₄, HAuCl₄ and mixtures thereof is dissolved in an alkylene glycol such as ethylene glycol, 1,2-butanediol, C4-C8 alkanols and mixtures thereof to yield a blend. The blend is refluxed at about 110° C. to about 190° C. for about 2 hrs to about 16 hrs to yield a sol of a redox active metal. Metal acetylacetonates that may be employed include but are not limited to Pt acetylacetonate, Au acetylacetonate, Sn acetylacetonate dichloride, Pb acetylacetonate, Zn acetylacetonate hydrate, mixtures thereof and alloys thereof.

The sol of redox active metal is mixed with an ionically conductive polymer solution to form an ionically conductive polymer-redox active metal composite electrolyte mixture. The mixture then may be cast into products such as membranes using techniques such as a doctor blade procedure such as described above.

Preparation of Separator Membranes Li+ PVDF-HFP Polymer-redox Active Pt Composite Electrolytes

PVDF-HFP membranes that have redox active Pt in the form of nanoparticles may be made by dissolving a Pt precursor such as platinum acetylacetonate in a lower alkylene glycol such as ethylene glycol to form a Pt precursor solution. The Pt precursor may be present in the Pt precursor solution in an amount of about 1 wt. % to about 10 wt. %, preferably about 1 wt. % to about 5 wt. % and the alkylene glycol may be present in the Pt precursor solution in an amount of about 90 wt. % to about 99 wt. %, all percentages based on the total weight of the precursor solution.

The precursor solution is refluxed to yield a Pt sol that has an average particle size of about 2 nm to about 10 nm, preferably about 10 nm. About 1 wt. % of the Pt sol to about 15 wt. % of the Pt sol, preferably about 1 wt % of the Pt sol to about 5 wt. % of the Pt sol is mixed with a solution of polymer to form an polymer-Pt redox additive blend. The treated blend then may be doctor bladed onto a glass substrate to produce a cast membrane sheet.

The cast membrane sheet may be dried such as for about 1 hour (ambient condition). The dried sheet then is subjected to phase inversion by contacting the sheet with absolute ethanol for 5 min. The resulting treated membrane sheet is removed from the substrate and immersed in absolute ethanol for 16 hrs and vacuum dried at 20° C. The dried membrane is immersed in a Li+ conducting polymer solution formed by dissolving 0.46 gms LiPF₆ in a 1:1 mixture by wt. of EC:DMC. The membrane then is immersed in the Li+ conducting solution for 2 days.

### Example P9

### Li+-PVDF-Pt Redox Additive Composite Electrolyte Membrane

0.63 gms of reagent grade platinum acetylacetonate are dissolved in 10 ml of ethylene glycol at 20° C. to form a metal precursor solution.

The precursor solution is refluxed at 190° C. for 5 hrs to yield a Pt sol of 10 nm Pt particles. 1 gm of PVDF-HFP granules from Sigma-Aldrich is dissolved in 9.5 ml reagent grade DMF at 20° C. to produce a PVDF/DMF solution.

1.9 gms of the Pt sol are mixed with 10 gm of 10 wt. % PVDF/DMF solution to form a blend. The blend of Pt particle in PVDF/DMF solution is subjected to ultrasonic vibration for 20 min to produce a treated blend. The treated blend is doctor bladed onto a glass substrate to produce a cast membrane sheet of 250 μm thickness. The cast membrane sheet is dried for 4 hours (ambient condition). The dried sheet then is subjected to phase inversion by contacting the membrane sheet with absolute ethanol for 5 min to form a treated membrane sheet. The treated membrane sheet is removed from the substrate and immersed in absolute ethanol for 16 hrs and then vacuum dried at 20° C. The resulting dried membrane then is immersed in a solution of 0.46 gm LiPF₆ in a 1:1 mixture by wt. of EC:DMC for 2 days to produce a Li+ conducting, Pt additive composite electrolyte in the form of a membrane having thickness of 240 μm.

### Example P10

### Li+-PVDF-Au Redox Additive Composite Electrolyte

0.63 gms of reagent grade gold acetylacetonate are dissolved in 10 ml of ethylene glycol at 20° C. to form a metal precursor solution.

The precursor solution is refluxed at 190° C. for 5 hrs to yield an Au sol of 10 nm Pt particles. 1 gm of PVDF-HFP granules from Sigma-Aldrich is dissolved in 9.5 ml reagent grade DMF at 20° C. to produce a PVDF/DMF solution.

1.9 gms of the Au sol are mixed with 10 gm of 10 wt. % PVDF/DMF solution to form a blend. The blend of Au particle in PVDF/DMF solution is subjected to ultrasonic vibration for 20 min to produce a treated blend.

The treated blend is doctor bladed onto a glass substrate to produce a cast membrane sheet of 250 μm thickness.

The cast membrane sheet is dried for 4 hours (ambient condition), subjected to phase inversion by contacting with absolute ethanol for 5 min, immersed in absolute ethanol for 16 hrs, vacuum dried at 20° C. and then is immersed in a solution of 0.46 gm LiPF₆ in a 1:1 mixture by wt. of EC:DMC for 2 days.

### Example P11

### Li+-PVDF-Sn Redox Additive Composite Electrolyte

0.63 gms of reagent grade tin acetylacetonate are dissolved in 10 ml of ethylene glycol at 20° C. to form a metal precursor solution. The precursor solution is refluxed at 190° C. for 5 hrs to yield an Sn sol of 10 nm Pt particles. 1 gm of PVDF-HFP granules from Sigma-Aldrich is dissolved in 9.5 ml (Reagent grade) DMF at 20° C. to produce a PVDF/DMF solution.

1.9 gms of the Sn sol are mixed with 10 gm of 10 wt. % PVDF/DMF solution to form a blend. The blend of Sn particle in PVDF/DMF solution is subjected to ultrasonic vibration for 20 min to produce a treated blend. The treated blend is doctor bladed onto a glass substrate to produce a cast membrane sheet of 250 μm thickness.

The cast membrane sheet is dried for 4 hours (ambient condition). The dried sheet then is subjected to phase inversion by contacting the membrane sheet with absolute ethanol for 5 min to form a treated membrane sheet. The treated membrane sheet is removed from the substrate and immersed in absolute ethanol for 16 hrs and then vacuum dried at 20° C. and them is immersed in a solution of 0.46 gm LiPF₆ in a 1:1 mixture by wt. of EC:DMC for 2 days.

### Example P12

### Li+-PVDF-Pb Redox Additive Composite Electrolyte

The procedure of example P10 is followed except that lead acetylacetonate is substituted for gold acetylacetonate.

### Example P13

### Li+-PVDF-Zn Redox Additive Composite Electrolyte

The procedure of example P10 is followed except that zinc acetylacetonate is substituted for gold acetylacetonate.

### Example P14

### Li+-PVDF-Si Redox Additive Composite Electrolyte

The procedure of example P10 is followed except that 0.05 gms of 100 nm size silicon particles from Reade Inc. are substituted for the gold acetylacetonate.

### Example P15

2 gms of Li+ conducting polymer such as PVDF is dissolved in 19 ml of DMF solvent along with 0.46 gms of LiPF₆ to form a Li+ conducting polymer solution. To this solution, 0.05 gms of Pt that have an average size of 10 nm are added. The resulting polymer solution is cast as a membrane according the procedure of example P1 and dried to constant weight at 20° C. to form a Li+ conducting polymer-Pt composite electrolyte.

### Use of Ionically Conducting Polymeric, Composite Membranes in Coin Cells

### Example C1

A membrane produced as in example P1 is employed as a separator electrolyte in a 2032 coin cell. In the cell, activated carbon that has a surface area of 1700 m²/g and is derived from polyfurfuryl alcohol is used as the cathode and lithium metal is used as the anode.

The cathode is made by mixing activated carbon, Teflon emulsion from Electrochem Inc. and acetylene black to form slurry. In the slurry, activated carbon is present in an amount of 85 wt. %, Teflon emulsion is present in an amount of 10 wt. % and acetylene black is present in an amount of 5 wt. %, all amounts based on the total weight of the slurry. The slurry is applied onto carbon paper to a thickness of 250 μm and then dried at 20° C. to form a current collector.

### Example C2

The procedure of example C1 is followed except that the membrane produced as in example P9 is employed.

### Example C3

The procedure of example C1 is followed except that the membrane produced as in example P2 is employed.

The performance of the coin cells is tested using electrochemical impedance spectroscopy and constant current charge/discharge. Electrochemical impedance measurements are made before and after charge/discharge measurements under open circuit voltage conditions. Charge/discharge measurements of the cells are made by using a constant load current of 100 mA/g based on the mass of activated carbon. The mass of the activated carbon used as the cathode is 1 mg. The cells are cycled between 5.2 V to 2 V for a minimum of 25 cycles. Charge/discharge measurements are repeated at 200 mA/g.

The performance of the coin cells produced as in examples C1-C3 is shown in Table 1. In Table 1, the performance of the coin cells is compared to the performance of a control coin cell. The control coin cell is the same as that of example C1 except that the membrane employed in the control cell is made according to the procedure of example P1 except that the membrane does not include MoO₃. The energy density calculations are based on total volume of the sample cell that includes that of activated carbon, lithium and polymer membrane.

TABLE 1

| | |
|---|---|
| Membrane Thickness | Energy Density (J cc⁻¹) |

| Sample | (micron) | 100 mA/g | 200 mA/g |
|---|---|---|---|
| Control | 25 | 26.2 | 19.5 |
| C1 | 25 | 108.9 | 98.9 |
| C2 | 240 | — | 105.8 |
| C3 | 240 | 38.6 | — |

### Ionically Conducting Glass, Redox Additive Composite Electrolytes

Ionically conducting glass, redox additive composite electrolytes include an ionically conducting glass and a redox additive. Ionically conducting glass may include but are not limited to ionically conducting chalcogenide glass, ionically conducting fluoride glass, ionically conducting oxide glass, ionically conducting phosphate glass, ionically conducting oxynitride glass, ionically conducting oxyfluoride glass, ionically conducting oxychloride glass, and mixtures thereof. Any of these glasses may be Ag⁺ conducting, F⁻ conducting, H⁺ conducting, K⁺ conducting, Li⁺ conducting, Mg²⁺ conducting, Na⁺ conducting, Mg²⁺ conducting, O²⁻ conducting, or combinations thereof.

Materials employed as ionically conductive glasses include but are not limited to ionically conductive glasses per se, mixtures of starting materials suitable for yielding an ionically conductive glass, and blends of ionically conductive glasses and those starting materials.

Li⁺ conductive chalcogenide glasses may include but are not limited to Li₂S—SiS₂—Li₄SiO₄, Li₂S—SiS₂—Li₃PO₄, Li₂S—P₂S₅—LiI, Li₂S—SiS₂—LiI, Li₂S—SiS₂, Li₂S—B₂S₃, Li₂S—P₂S₅, Li₂S—GeS₂, Li₂S—Ga₂S₃—GeS₂, Li₂S—Ga₂S₃—GeS₂ doped with iodide dopants such as LiI, Li₂S—Ga₂S₃—GeS₂ doped with iodide dopants such as LiI, Li₂S—Sb₂S₃—GeS₂, Li₂S—GeS₂—P₂S₅, Li₃PO₄—Li₂S—SiS₂, Li₂S—GeS₂—P₂S₅, and mixtures thereof.

Li+ conducting fluoride glasses may include but are not limited to ZrF₄—BaF₂—LaF₃—LiF and mixtures thereof. Li+ conducting oxide, oxychloride and oxyfluoride glasses may include but are not limited to Li—F—B—O compositions such as but not limited to Li₂O—LiF—B₂O₃ and mixtures thereof; Li—B—O compositions such as but not limited to Li₄SiO₄—Li₃BO₃, Li₂O—B₂O₃ and mixtures thereof; Li—Cl—B—O compositions such as but not limited to Li₂O—LiCl—B₂O₃ and mixtures thereof; Li—B—S—O compositions such as but not limited to Li₂SO₄—Li₂O—B₂O₃ and mixtures thereof. Li+ conducting oxynitride glasses may include but are not limited to Lithium phosphate oxynitrides and mixtures thereof.

The redox active additive employed in an ionically conducting glass may be in the form of redox active metals, redox active oxides, redox active oxynitrides, and mixtures thereof. Redox active metals that may employed include but are not limited to Au, Pt, Pd, Sn, Al, Fe, Sb, Sn alloys, Sb alloys, Si, Ge alloys thereof and mixtures thereof. Where Au particles are employed, the particles may vary in size from about 3 nm to about 190 nm, preferably about 3 nm to about 10 nm, more preferably about 10 nm.

Redox active oxides that may employed include but are not limited to antimony oxide, bismuth oxide, chromium oxide, cobalt oxide, copper oxide, germanium oxide, indium oxide, iron oxide, lead oxide, lithium cobalt oxide, lithium oxide, lithium titanate, lithium vanadium, lithium vanadium oxide, lithium phosphorous oxide, phosphorous oxide, lithium iron oxide, iron phosphorous oxide manganese oxide, molybdenum oxide, niobium oxide, silver oxide, strontium oxide, tantalum oxide, tin oxide, titanium oxide, tungsten oxide, vanadium oxide, zinc oxide and mixtures thereof. Redox active oxynitrides that may be employed include but are not limited to Li_{7.9}MnN_{3.2}O_{1.6} and mixtures thereof.

The redox active additive employed in manufacture of ionically conductive glass, redox active composite electrolytes may be in the form of solutions of precursors of the redox active additive, solutions of the redox additive, and particles of the redox active additive. Where particles of the redox active additive are employed, the particle size of the redox active additives may vary from about 1 nm to about 500 nm.

Ionically conducting glass, redox active additive composite electrolytes may be made by melting a mixture of redox active additives and ionically conductive glasses. The amounts of ionic conducting glass and redox additive in an ionic conducting glass-redox additive composite electrolyte may vary over a wide range. The amount of redox additive employed in an ionic conducting glass-redox additive composite electrolyte is sufficient to achieve an ionically conductive glass-redox additive composite electrolyte that has an increased ionic current and/or higher voltage compared to the ionically conductive glass employed in the ionically conductive glass-redox additive composite electrolyte. Typically, the redox additive is present in an amount of about 0.1 wt. % to about 50 wt. %, preferably about 5 wt. % to about 20 wt. % based on the weight of the ionic conducting conductive glass.

The amount of redox additive employed in an ionic conducting glass-ceramic redox additive composite electrolyte is sufficient to achieve an ionically conductive glass-ceramic-redox additive composite electrolyte that has an increased ionic current and/or higher voltage compared to the ionically conductive glass-ceramic employed in the ionically conductive glass-ceramic-redox additive composite electrolyte. Generally, the redox additive is present in an amount of about 0.5 wt. % to about 20 wt. %, preferably about 5 wt. % to about 10 wt. % of the amount of the ionic conducting glass-ceramic.

The amount of redox additive employed in an ionic conducting ceramic-redox additive composite electrolyte is sufficient to achieve an ionically conductive ceramic-redox additive composite electrolyte that has an increased ionic current compared to the ionically conductive ceramic employed in the ionically conductive ceramic-redox additive composite electrolyte. Generally, the redox additive is present in an amount of about 0.5 wt. % to about 20 wt. %, preferably about 5 wt. % to about 10 wt. % of the amount of the ionic conducting conductive ceramic.

Where the ionic conducting glass is an Ag+ conducting glass such as any of Ag+ conductive chalcogenide glasses, Ag+ conducting fluoride glasses, Ag+ conducting oxide glasses and mixtures thereof, the amount of redox active additive employed is sufficient achieve an Ag+ conductive glass-redox additive composite electrolyte that has an increased ionic current compared to the Ag+ conductive glass employed in the Ag+ conductive glass-redox additive composite electrolyte. Typically, the amount of redox active additive is about 0.1 wt. % to about 50 wt. % of the Ag+ conducting glass.

Where the ionic conducting glass is a Cs+ conducting glass such as any of Cs+ conductive chalcogenide glasses, Cs+ conducting fluoride glasses, Cs+ conducting oxide glasses and mixtures thereof, the amount of redox active additive employed is sufficient to achieve a Cs+ conductive glass-redox additive composite electrolyte that has an increased ionic current compared to the Cs+ conductive glass employed in the Cs+ conductive glass-redox additive composite electrolyte. Typically, the amount of redox active additive is about 0.1 wt. % to about 50 wt. % of the Cs+ conducting glass.

Where the ionic conducting glass is a F— conducting glass such as any of F— conductive chalcogenide glasses, F— conducting fluoride glasses, F— conducting oxide glasses and mixtures thereof, the amount of redox active additive employed is sufficient to achieve a F— conductive glass-redox additive composite electrolyte that has an increased ionic current compared to the F— conductive glass employed in the F— conductive glass redox additive composite electrolyte. Typically, the amount of redox active additive is about 0.1 wt. % to 50 wt. % of the F— conducting glass.

Where the ionic conducting glass is a H+ conducting glass such as any of H+ conductive chalcogenide glasses, H+ conducting fluoride glasses, H+ conducting oxide glasses and mixtures thereof, the amount of redox active additive employed is sufficient to achieve a H+ conductive glass-redox additive composite electrolyte that has an increased ionic current compared to the H+ conductive glass employed in the H+ conductive glass-redox additive composite electrolyte.

Where the ionic conducting glass is a K+ conducting glass such as any of K+ conductive chalcogenide glasses, K+ conducting fluoride glasses, K+ conducting oxide glasses and mixtures thereof, the amount of redox active additive employed is sufficient to achieve a K+ conductive glass-redox additive composite electrolyte that has an increased ionic current compared to the K+ conductive glass employed in the K+ conductive glass-redox additive composite electrolyte. Typically, the amount of redox active additive is about 0.1 wt. % to about 50 wt. % of the K+ conducting glass.

Where the ionic conducting glass is a Li+ conducting glass such as any of Li+ conductive chalcogenide glasses, Li+ conducting fluoride glasses, Li+ conducting oxide glasses and mixtures thereof; the amount of redox active additive employed is sufficient to achieve a Li+ conductive glass-redox additive composite electrolyte that has an increased ionic current compared to the Li+ conductive glass employed in the Li+ conductive glass-redox additive composite electrolyte. Typically, the amount of redox active additive is about 0.1 wt. % to about 50 wt. % of the Li+ conducting glass.

Where the ionic conducting glass is a Na+ conducting glass such as any of Na+ conductive chalcogenide glasses, Na+ conducting fluoride glasses, Na+ conducting oxide glasses and mixtures thereof, the amount of redox active additive employed is sufficient to achieve a Na+ conductive glass-redox additive composite electrolyte that has an increased ionic current compared to the Na+ conductive glass employed in the Na+ conductive glass-redox additive composite electrolyte. Typically, the amount of redox active additive is about 0.1 wt. % to about 50 wt. % of the Na+ conducting glass.

Where the ionic conducting glass is an O²⁻ conducting glass such as any of O²⁻ conducting oxyfluoride glasses, O²⁻ conducting oxide glasses and mixtures thereof, the amount of redox active additive employed is sufficient to achieve an O²⁻ conductive glass-redox additive composite electrolyte that has an increased ionic current compared to the O²⁻ conductive glass employed in the O²⁻ conductive glass-redox additive composite electrolyte. Typically, the amount of redox active additive is about 0.1 wt. % to about 50 wt. % of the O²⁻ conducting glass.

### Ionically Conducting Glass-Ceramic, Redox Additive Composite Electrolytes

Ionically conducting glass-ceramic, redox additive composite electrolytes include an ionically conducting glass-ceramic and a redox additive. Ionically conducting glass-ceramics may include but are not limited to chalcogenide glass-ceramics, fluoride glass-ceramics, oxide glass-ceramics, phosphate glass-ceramic, sulfide glass-ceramic and mixtures thereof. Any of these glass-ceramics may be Ag⁺ conducting, F⁻ conducting, H⁺ conducting, K⁺ conducting, Li⁺ conducting, Mg²⁺ conducting, Na⁺ conducting, O²⁻ conducting, or combinations thereof.

Ionic conductive chalcogenide glass-ceramics may include but are not limited to Li₂S—P₂S₅ glasses and mixtures thereof. Ionic conducting oxide glass-ceramics may include but not limited to Lithium aluminum Germanium Phosphate glass-ceramics and mixtures thereof.

The redox active additive employed in an ionically conducting glass-ceramics may be in the form of redox active metals, redox active oxides, redox active oxynitrides and mixtures thereof. Redox active metals that may employed include but are not limited to Au, Pt, Pd, Sn, Al, Fe, Sb, Cu—Sn alloys, Cu—Sb alloys, Si, alloys thereof and mixtures thereof. Where Au particles are employed, the particles may vary in size from about 3 nm to about 200 nm. Redox active oxides may include but are not limited to antimony oxide, barium oxide, bismuth oxide, boron oxide, calcium oxide, chromium oxide, cobalt oxide, copper oxide, germanium oxide, indium oxide, iron oxide, lead oxide, lithium cobalt oxide, lithium oxide, lithium titanate, lithium iron phosphorous oxide, iron phosphorous oxide, phosphorous oxide, lithium vanadium oxide, manganese oxide, molybdenum oxide, niobium oxide, silver oxide, tin oxide, titanium oxide, tungsten oxide, vanadium oxide, zinc oxide and mixtures thereof. Redox active oxynitrides that may be employed include but are not limited to Li_{7.9}MnN_{3.2}O_{1.6} and mixtures thereof.

The redox active additive employed in manufacture of ionically conductive glass-ceramics, redox active composite electrolytes may be in the form of solutions of precursors of the redox active additive, solutions of the redox additive, and particles of the redox active additive. Where particles of the redox active additive are employed, the particle size of the redox active additives may vary from about 1 nm to about 500 nm.

Ionically conducting glass-ceramics, redox active additive composite electrolytes may be made by forming a melt of a mixture of ionically conducting glass and redox active additives. Materials employed as ionically conductive glass-ceramics may include but are not limited to ionically conductive glass-ceramics per se, mixtures of starting materials suitable for yielding an ionically conductive glass-ceramics, and blends of ionically conductive glasses-ceramics and those starting materials.

The amounts of ionic conducting glass-ceramics and redox additive in an ionic conducting glass-ceramics-redox additive composite electrolyte may vary over a wide range. The amount of redox additive employed in an ionic conducting glass-ceramics-redox additive composite electrolyte is sufficient to form a glass-ceramic-redox additive composite electrolyte that has an ionic current greater than that of the ionic conducting glass-ceramic employed in the composite electrolyte. Typically, the redox additive is present in an amount of about 0.1 wt. % to about 50 wt. %, preferably 0.1 wt. % to about 40 wt. %, preferably about 1 wt. % to about 25 wt. %, more preferably about 1 wt. % to about 20 wt. % based on the weight of the ionic conducting glass-ceramics.

Where the ionic conducting glass-ceramics is an Ag+ conducting glass-ceramics such as any of Ag+ conductive chalcogenide glass-ceramics, Ag+ conducting fluoride glass-ceramics, Ag+ conducting oxide glass-ceramics and mixtures thereof, the amount of redox active additive employed is sufficient to achieve an Ag+ conducting glass ceramic-redox additive composite electrolyte that has an ionic current greater than that of the Ag+ conducting glass-ceramic employed in the composite electrolyte. Typically, the amount of redox active additive is about 0.1 wt. % to about 30 wt. % of the weight of the Ag⁺ conducting glass-ceramic.

Where the ionic conducting glass-ceramics is a F— conducting glass-ceramics such as any of F— conductive chalcogenide glass-ceramics, F— conducting fluoride glass-ceramics, F— conducting oxide glass-ceramics and mixtures thereof, the amount of redox active additive employed is sufficient to achieve a F— conducting glass ceramic-redox additive composite electrolyte that has an ionic current greater than that of the F— conducting glass ceramic employed in the composite electrolyte. Typically, the amount of redox active additive is about 0.1 wt. % to about 30 wt. % of the F— conducting glass-ceramic.

Where the ionic conducting glass-ceramics is a Li+ conducting glass-ceramics such as any of Li+ conductive chalcogenide glass-ceramics, Li+ conducting fluoride glass-ceramics, Li+ conducting oxide glass-ceramics and mixtures thereof, the amount of redox active additive employed is sufficient to achieve an Li+ conducting glass ceramic-redox additive composite electrolyte that has an ionic current greater than that of the Li+ conducting glass-ceramic employed in the composite electrolyte. Typically, the amount of redox active additive is about 0.1 wt. % to about 40 wt. % of the Li+ conducting glass-ceramics.

Where the ionic conducting glass-ceramics is a Na+ conducting glass such as any of Na+ conductive chalcogenide glass-ceramics, Na+ conducting fluoride glass-ceramics, Na+ conducting glass-ceramics and mixtures thereof, the amount of redox active additive employed is sufficient to achieve an Na+ conducting glass-ceramic-redox additive composite electrolyte that has an ionic current greater than that of the Na+ conducting glass-ceramic employed in the composite electrolyte. Typically, the amount of redox active additive is about 0.1 wt. % to about 50 wt. % of the Na+ conducting glass-ceramics.

Where the ionic conducting glass-ceramics is an O²⁻ conducting glass-ceramics such as any of O²⁻ conductive chalcogenide glass-ceramics, O²⁻ conducting fluoride glass-ceramics, O²⁻ conducting oxide glass-ceramics and mixtures thereof, the amount of redox active additive employed is sufficient to achieve an O²⁻ conducting glass-ceramic-redox additive composite electrolyte that has an ionic current greater than that of the O²⁻ conducting glass-ceramic employed in the composite electrolyte. Typically, the amount of redox active additive is about 0.1 wt. % to about 50 wt. % of the O²⁻ conducting glass-ceramics.

### In Situ Formed Redox Active Species in Ionically Conducting Glasses and Glass-Ceramics

In situ formed redox active species ionically conducting glasses and in situ formed redox active species ionically conducting glass-ceramics each include an ionically conducting glass or glass-ceramic and a redox additive species which form in situ. Ionically conducting glasses and glass-ceramics may include but are not limited to chalcogenide glasses and glass-ceramics, fluoride glasses and glass-ceramics, oxide glasses and glass-ceramics, phosphate glasses and glass-ceramics, and mixtures thereof. Any of these ceramic may be Ag⁺ conducting, F⁻ conducting, H⁺ conducting, K⁺ conducting, Li⁺ conducting, Mg²⁺ conducting, Na⁺ conducting, O²⁻ conducting, or combinations thereof. Ionic conductive chalcogenide glass-ceramics that may be employed include but are not limited to Li₂S—P₂S₅ and mixtures thereof.

The redox active additive employed in an ionically conducting glass or glass-ceramic may be in the form of redox active metals, redox active oxides, redox active oxynitrides and mixtures thereof. Redox active metals that may employed include but are not limited to Au, Pt, Pd, Sn, Al, Sb, Fe, Cr, Cu—Sn alloys, Cu—Sb alloys, Si, Ge alloys thereof and mixtures thereof. Where Au particles are employed, the particles may vary in size from about 3.0 nm to about 500 nm.

Redox active oxides may include but are not limited to antimony oxide, chromium oxide, cobalt oxide, copper oxide, germanium oxide, indium oxide, iron oxide, lead oxide, lithium cobalt oxide, lithium oxide, lithium titanate, lithium vanadium oxide, manganese oxide, molybdenum oxide, niobium oxide, silver oxide, tin oxide, titanium oxide, tungsten oxide, vanadium oxide, zinc oxide and mixtures thereof. Redox active oxynitrides that may be employed include but are not limited to Li_{7.9}MnN_{3.2}O_{1.6} and mixtures thereof.

The redox active additive employed in manufacture of ionically conductive glasses and glass-ceramics, in situ formed redox active species composite electrolytes may be in the form of solutions of precursors of the redox active additive, solutions of the redox additive, and particles of the redox active additive. Where particles of the redox active additive are employed, the particle size of the redox active additives may vary from about 1 nm to about 100 nm primary particle size.

Ionically conducting glass and glass-ceramic, in situ formed redox active species composite electrolytes may be made by melting a mixture of ionically conductive glasses and glass-ceramic and redox active additives. Alternatively, ionically conducting glass and glass-ceramic, redox active additive composite electrolyte may be made by chemistries that segregate within the microstructure.

Materials employed as ionically conductive glass and glass-ceramic may include but are not limited to ionically conductive glass and glass-ceramic per se, mixtures of starting materials suitable for yielding an ionically conductive glass and glass-ceramic, and blends of ionically conductive glass and glass-ceramic and those starting materials. The amounts of ionic conducting glass and glass-ceramic and redox additive in an in-situ formed redox active species ionic conducting glass and glass-ceramic electrolyte may vary over a wide range. The amount of redox additive present in an ionic conducting glass or glass-ceramic electrolyte is sufficient to achieve an ionic conducting glass or glass-ceramic-redox additive composite electrolyte that has an ionic current greater than that of the ionic glass or glass-ceramic employed in the electrolyte. Typically, the redox additive is present in an amount of about 0.01 wt. % to about 60 wt. %, preferably about 0.1 wt. % to about 25 wt. %, more preferably about 10 wt. % to about 25 wt. %, yet more preferably about 5 wt. % to about 20 wt. % of the amount of the ionic conducting ceramic.

Where the ionic conducting glass or glass-ceramic is an Ag+ ceramic such as any of Ag+ conductive chalcogenide glass and glass-ceramic, Ag+ conducting fluoride glass and glass-ceramic, Ag+ conducting oxide glass and glass-ceramic and mixtures thereof, the amount of redox active additive employed is sufficient to achieve an Ag+ conducting glass or glass-ceramic-in situ formed redox active additive composite electrolyte that has an ionic current greater than that of the Ag+ conducting glass or glass-ceramic employed in the electrolyte. Typically, the amount of redox active additive is about 0.5 wt. % to about 40 wt. % of the Ag+ conducting glass or glass-ceramic.

Where the ionic conducting ceramic is a F— conducting glass or glass-ceramic such as any of F— conductive chalcogenide glass and glass-ceramic, F— conducting fluoride glass and glass-ceramic, F— conducting oxyfluoride glass and glass-ceramic and mixtures thereof. The amount of redox active additive employed is sufficient to achieve a F— conducting glass or glass-ceramic-in situ formed redox active additive composite electrolyte that has an ionic conductivity greater than that of the F— conducting glass or glass-ceramic employed in the electrolyte. Typically, the amount of redox active additive is about 0.1 wt. % about 50 wt. % of the F— conducting glass or glass-ceramic.

Where the ionic conducting ceramic is a H+ conducting glass or glass-ceramic such as any of H+ conductive chalcogenide glass and glass-ceramic, H+ conducting fluoride glass and glass-ceramic, H+ conducting oxyfluoride glass and glass-ceramic and mixtures thereof. The amount of redox active additive employed is sufficient to achieve a H+ conducting glass or glass-ceramic-in situ formed redox active additive composite electrolyte that has an ionic conductivity greater than that of the H+ conducting glass or glass-ceramic employed in the electrolyte. Typically, the amount of redox active additive is about 0.1 wt. % about 50 wt. % of the H+ conducting glass or glass-ceramic.

Where the ionic conducting ceramic is a Li+ conducting glass or glass-ceramic such as any of Li+ conductive chalcogenide glass and glass-ceramic, Li+ conducting fluoride glass and glass-ceramic, Li+ conducting oxyfluoride glass and glass-ceramic and mixtures thereof. The amount of redox active additive employed is sufficient to achieve a Li+ conducting glass or glass-ceramic-in situ formed redox active additive composite electrolyte that has an ionic conductivity greater than that of the Li+ conducting glass or glass-ceramic employed in the electrolyte. Typically, the amount of redox active additive is about 0.1 wt. % about 50 wt. % of the Li+ conducting glass or glass-ceramic.

Where the ionic conducting ceramic is a Na+ conducting glass or glass-ceramic such as any of Na+ conductive chalcogenide glass and glass-ceramic, Na+ conducting fluoride glass and glass-ceramic, Na+ conducting oxyfluoride glass and glass-ceramic and mixtures thereof. The amount of redox active additive employed is sufficient to achieve a Na+ conducting glass or glass-ceramic-in situ formed redox active additive composite electrolyte that has an ionic conductivity greater than that of the Na+ conducting glass or glass-ceramic employed in the electrolyte. Typically, the amount of redox active additive is about 0.1 wt. % about 50 wt. % of the Na+ conducting glass or glass-ceramic.

Where the ionic conducting ceramic is a O²⁻ conducting glass or glass-ceramic such as any of O²⁻ conductive chalcogenide glass and glass-ceramic, O²⁻ conducting fluoride glass and glass-ceramic, O²⁻ conducting oxyfluoride glass and glass-ceramic and mixtures thereof. The amount of redox active additive employed is sufficient to achieve an O²⁻ conducting glass or glass-ceramic-in situ formed redox active additive composite electrolyte that has an ionic conductivity greater than that of the O²⁻ conducting glass or glass-ceramic employed in the electrolyte. Typically, the amount of redox active additive is about 0.1 wt. % about 50 wt. % of the O²⁻ conducting glass or glass-ceramic.

### Manufacture of Ionically Conducting Glass, Redox Active Additive Composite Electrolytes

Generally, ionically conducting glass, redox additive composite electrolytes may be made from a mixture that includes a redox active additive, one or more glass former oxides, an optional glass modifier oxide, and one least one oxide that serves as a source of conductive ions such as but not limited to one or more of Ag⁺, F⁻, H⁺, K⁺, Li⁺, Mg²⁺, Na⁺, and O²⁻. The mixture then is melted and cooled to form an ionically conducting glass, redox additive composite electrolyte. Alternatively, an ionically conducting glass, redox additive composite electrolyte may be made by adding an oxide that serves as a source of conductive ions to a melt of a glass such as an oxide glass, a chalcogenide glass, a phosphate glass and mixtures thereof that includes a redox active additive. As a further alternative, an ionically conducting glass, redox additive composite electrolyte may be made by adding a redox active additive to milled with the ionically conductive glass.

### Manufacture of Li+ Conducting Germanium Phosphate Glass-Ceramic-Redox Active Composite Electrolyte

A composition formed from a mixture of Li⁺ precursor material such as Li₂CO₃, phosphate precursor such as NH₄H₂PO₄, an optional glass modifier such as Al₂O₃, and glass former such as Ge₂O₃ is milled to produce a ground powder. The milled powder may be calcined at about 750° C. to about 850° C. for about 30 min to about 60 min to produce a calcined material. The calcined material again may be milled to produce milled material. The milled material may be melted at about 1200° C. to about 1400° C. for about 2 hrs to about 4 hrs to produce a melt. The melt may be quenched by casting onto motorized rollers at about 1400° C. to about 1100° C. to form glass sheets. The glass sheets then may be optionally annealed at about 450° C. to about 550° C. for about 1 hr to about 3 hr. and then cooled to room temperature at about 1° C./min to about 2° C./min to produce a cooled Li+ conducting phosphate germanium glass sheet.

The Li+ conducting phosphate germanium glass may be crushed, milled and mixed with about 0.1 wt. % to about 40 wt. % of a redox active additive and ball milled in a lower alkanol such as ethanol to yield ground slurry. The ground slurry may be passed through a 300-mesh sieve to produce screened slurry that is dried at about 80° C. to about 120° C. form milled powder. The milled powder is mixed with about 5 wt. % to about 20 wt. % binder and plasticizer in an amount of up to about 5 wt. %, all amounts based on the weight of the milled powder, to form a binder-powder mixture that is mixed with a solvent blend such as 50/50 MEK/ethanol to form slurry that may be cast into tape. Binders that may be employed include but are not limited to Poly Vinyl Butyral, Poly(propylene carbonate), polyvinyl alcohol and mixtures thereof. Plasticizers that may be used include but are not limited to di-octyl phthalate, butyl benzyl phthalate, propylene carbonate and mixtures thereof. The cast tapes may be electroded such as by screen-printing thick film conductive ink such as platinum, gold or palladium silver on to the tapes. The resulting printed tapes then may be aligned and laminated such as in an isostatic press at about 50° C. to about 80° C. at about 3000 psi to 4000 psi for about 10 min to about 30 min to produce a green laminate. The green laminate is fired at about 800° C. to about 1000° C. for about 1 hour to about 12 hours in order to form a ceramic, redox additive composite electrolyte.

### Example LGC1 Li Phosphate Germanium Glass-SnO₂ Composite Electrolyte

A composition formed from a mixture of 3.74 gms Li₂CO₃, 27.92 gms NH₄H₂PO₄, 1.04 gms Al₂O₃, 14.81 gms Ge₂O₃ and 5.42 gms SnO₂ is milled to produce a ground powder. The milled powder is calcined at 750° C. for 30 min to produce a calcined material. The calcined material is again milled for 24 hrs to produce milled material. The milled material is heated at 1350° C. for 2 hrs to produce a melt. The melt is quenched by casting onto motorized rollers at 1300° C. to form glass sheets. The glass sheets are heated at 450° C. for 1 hr. and cooled to room temperature at 1° C./min to produce a cooled glass sheet. The cooled, glass sheet is heat-treated at 850° C. for 2 hrs to form Li⁺ conducting lithium aluminum phosphate germanium glass-ceramic in which redox active SnO₂ phase is formed.

### Example LGC2

A composition formed from a mixture of 1.53 gms Li₂CO₃, 11.44 gms NH₄H₂PO₄, 0.42 gms Al₂O₃, 6.07 gms Ge₂O₃ and 5.00 gms HAuCl₄.3H₂O is milled to produce a ground powder. The milled powder is calcined at 750° C. for 30 min to produce a calcined material. The calcined material is again milled for 24 hrs to produce milled material. The milled material is heated at 1350° C. for 2 hrs to produce a melt. The melt is quenched by casting onto motorized rollers at 1300° C. to form glass sheets. The glass sheets are heated at 450° C. for 1 hr. and cooled to room temperature at 1° C./min to produce a cooled glass sheet. The cooled, glass sheet is heat-treated at 950° C. for 2 hrs to form Li+ conducting lithium aluminum phosphate germanium glass-ceramic in which redox active gold nano particles are distributed.

### Manufacture of Ionically Conducting Ceramic, Redox Additive Composite Electrolytes

An ionically conducting ceramic, redox additive composite electrolyte may be made by forming a mixture of one or more ionically conducting ceramic materials with one or more redox active ceramic additives. The mixture is ground, dried, and fired to form an ionically conducting ceramic, redox additive composite electrolyte. The mixture employed may be random, uniform, non-uniform or graded through its thickness. The redox active additive employed with the ionically conducting ceramic material is selected based on its ability to undergo redox reactions with the ionically conducting species in the ceramic material. To illustrate, where the ionically conducting ceramic is a Li+ conducting ceramic such as (Lila)TiO₃, the redox active ceramic additive is selected based on its ability to undergo redox reactions with Li. Li+ conducting ceramics that may be employed in manufacture of Li+ conducting ceramic, redox additive composite electrolytes include but are not limited to Li+ conducting garnet type ceramics such as but not limited to Li₂La₃Zr₂O₁₂, Li₅La₃M₂O₁₂ (where M=Ta, Nb), Lithium Super Ionic

Conductor (LISICON) type ceramics such as but not limited to Li₁₄ZnGe₄O₁₆Li_{3.4}Si_{0.4}P_{0.6}S₄. Li₃PO₄ based ceramics such as but not limited to Li₂Ge₂(PO₄)₃ and Li₁₊ₓTi₂₋ₓMₓ(PO₄)₃ (where M=Al, Ga, In, Sc), binary nitrides such as but not limited to Li₃N, and lithium salts such as but not limited to Li₄SiO₄ and mixtures thereof.

Redox active additives that may be employed with ionic conducting ceramics such as Li+ conducting ceramics include but are not limited to, LiMn₂O₄ LiCoO₂, LiNiO₂, LiFeO₂, Liₓ(Co_{y}Al_{1-y})₍₁₋ₓ₎O₂ where 0<x<1, 0<y<1 and mixtures thereof.

The mixture of ionically conducting ceramic material and redox active ceramic additive may be ball milled in a suitable liquid such as ethanol, water, acetone or blends thereof to produce milled powder. The milled powder may be blended with up to about 5 wt. % of a binder such as polyvinyl butyral, polyvinyl alcohol, polymethyl methacrylate, polyethylene oxide and mixtures thereof to form a binder-powder mixture. The binder-powder mixture may be compressed under uniaxial pressure followed by compression in an isostatic press to produce a preform that then may be fired. Alternatively, the milled powder is mixed with about 5 wt. % to about 50 wt. % binder and optional plasticizer in an amount of up to about 5 wt. %, all amounts based on the weight of the milled powder, to form a binder-powder mixture that is mixed with a solvent blend such as 50/50 solvent blend of MEK/ethanol to form slurry that may be tape cast. Binders that may be employed include but are not limited to PVB, Poly(alkylene carbonate), PEO and mixtures thereof. Plasticizers that may be used include but are not limited to di-octyl phthalate, butyl benzyl phthalate and mixtures thereof. The cast tapes then may be electroded by screen-printing thick film conductive ink such as platinum or palladium silver on to the tapes. The printed tapes then may be aligned and laminated such as in an isostatic press at about 50° C. to about 80° C. at about 3000 psi to 4000 psi for about 10 min to about 30 min to produce a green laminate. The green laminate is fired at about 1150° C. to about 700° C. for about 1 hour to about 4 hours to form a ceramic, redox additive composite electrolyte. Alternatively, the green tapes may be employed in an unfired condition as ceramic-polymer redox additive composite electrolytes.

The composite electrolytes of each embodiment may be electroded by sputtering, evaporation or by silkscreen printing methods. Examples of metals that may be used for electrodes include Al, Ag, Pt, alloys thereof and mixtures thereof. The electrodes may be redox active.

### Example LC1

### (Li_{0.33}La_{0.55})TiO₃₋₈ Ceramic-LiCoO₂ Redox Composite Electrolyte

A mixture of 96.644 gms of La₂O₃, 59.900 gms of TiO₂ and 9.145 gm LiCO₃ is ball-milled in ethanol for 24 hrs to produce slurry. The slurry is dried at 80° C. for 8 hrs to form dried powder. The dried powder is calcined at 900° C. for 6 hrs to produce calcined powder. The calcined powder is ball-milled in ethanol for 16 hrs, dried at 80° C. for 24 hrs, and calcined at 1100° C. for 6 hrs to produce (Li_{0.33}La_{0.55}) TiO₃₋₈ electrolyte powder.

The (Li_{0.33}La_{0.55})TiO₃₋₈ electrolyte powder is ball milled with 10% weight of LiCoO₂ based on the weight of the electrolyte powder in ethanol for 24 hrs to produce a blended milled powder of (Li_{0.33}La_{0.55})TiO₃₋₈ ceramic-LiCoO₂ redox composite electrolyte. The blended milled powder is dried at 80° C. for 8 hrs and compressed into pellets under uniaxial pressure of 200 MPa, followed by compaction in a cold isostatic press at 250 MPa.

### Example LC2

### (Li_{0.33}La_{0.55})TiO₃₋₈ Ceramic-MoO₃ Redox Composite Electrolyte

A mixture of 96.644 gms of La₂O₃, 59.900 gms of TiO₂, 9.145 gm LiCO₃ is ball-milled in ethanol for 24 hrs to produce slurry. The slurry is dried at 80° C. for 8 hrs to form dried powder. The dried powder is calcined at 900° C. for 6 hrs to produce calcined powder. The calcined powder is ball-milled in ethanol for 16 hrs, dried at 80° C. for 24 hrs, and calcined at 1100° C. for 6 hrs to produce (Li_{0.33}La_{0.55})TiO₃₋₈ electrolyte powder.

The (Li_{0.33}La_{0.55})TiO₃₋₈ electrolyte powder is ball milled with 10% 100 nm size MoO₃ by weight based on the weight of the electrolyte powder in ethanol for 24 hrs, dried at 80° C. for 8 hrs, compressed under uniaxial pressure of 200 MPa, followed by isostatic compression at 250 MPa.

### Example LC3

### Li₇La₃Zr₂O₁₂Ceramic-LiCoO₂ Redox Composite Electrolyte

29.32 gms of La₂O₃, 17.069 Li₂CO₃ and 14.786 gms of ZrO₂ are mixed by ball milling with ZrO₂ balls in 2-propanol for 24 hrs to produce slurry. The slurry is dried and the resulting dried powder is calcined at 900° C. for 6 hrs. The calcined powder is milled, dried and calcined at 1100° C. for 6 hrs to obtain Li₇La₃Zr₂O₁₂ ceramic electrolyte.

The Li₇La₃Zr₂O₁₂ ceramic electrolyte is ball milled with 10% weight of LiCoO₂ based on the weight of the electrolyte powder in ethanol for 24 hrs to produce a blended milled powder of Li₇La₃Zr₂O₁₂ceramic-LiCoO₂ redox composite electrolyte. The blended milled powder is dried at 80° C. for 8 hrs and compressed into pellets under uniaxial pressure of 200 MPa, followed by compaction in a cold isostatic press at 250 MPa.

Redox active additive composite electrolytes that employ redox active additives such as in the form of particulate inclusions such as those disclosed herein may be employed in various electrochemical components in a variety of devices such as but not limited to energy storage devices, Li-ion hybrid composite membranes, gas separation membranes, membranes for hydrogen separations, membranes for water desalinization, potentiometric chemical sensors and electrochromic devices.

Examples of energy storage devices where redox active additives may be employed include but are not limited to batteries, capacitors, hybrid-battery capacitors and fuel cells. Examples of batteries in which redox active additive composite electrolytes may be employed include but are not limited to metal-air batteries such as but not limited to Li-air type batteries and Mg-air metal-air type batteries; primary batteries such as but not limited to Li ion type primary batteries and Mg-ion type primary batteries; secondary batteries such as but not limited to Li-ion type secondary batteries, proton-ion type secondary batteries and Mg-ion type secondary batteries; high temperature batteries such as but not limited to Na—S type-high temperature batteries and LiZr₂(PO₄)₃(“LiZP”) type-high temperature batteries. Examples of capacitors in which redox active additive composite electrolytes may be employed include but are not limited to electrochemical capacitors, protonic capacitors such as but not limited to KOH protonic type capacitors and H₃PO₄ electrolyte protonic type capacitors; Li-ion capacitors such as but not limited to PVDF Li-ion type capacitors where the lithium salt is, such as LiPF6, LiClO4, LiTFSi salt; PEO Li-ion type capacitors and with lithium salt is, such as, LiCl, LiBr, LiClO4 salt; high temperature capacitors such as but not limited to LAGP glass ceramic type high temperature capacitors and chalcogenide type high temperature capacitors. Examples of hybrid battery-capacitors in which redox active additive composite electrolytes may be employed include but are not limited to Li-ion hybrid type battery-capacitors. Examples of fuel cells in which redox active additive composite electrolytes may be employed include but are not limited to ZrO₂ based Solid Oxide type Fuel Cells.

Examples of Li-ion hybrid composite membranes in which redox active additive composite electrolytes may be employed include but are not limited to Li metal/PVDF/carbon hybrid composite membranes and Li—Fe Phosphate hybrid type composite membranes.

Examples of gas separation membranes in which redox active additive composite electrolytes may be employed include but are not limited to lanthanum strontium vanadate (LSV, La_{0.7}Sr_{0.3}VO₃)/yttria-stabilized zirconia (YSZ) composite electrolyte type gas separation membranes and LSV/gadolinium-doped ceria (GDC) type gas separation membranes.

Examples of potentiometric chemical sensors in which redox active additive composite electrolytes may be employed include but are not limited to MnO₂ doped lithium borosilicate glass type potentiometric chemical sensors.

Examples of electrochromic devices in which redox active additive composite electrolytes may be employed include but are not limited to devices that employ PVDF-HFP electrolytes having one or more oxide fillers such as MoO₃ and V₂O₅.

Li-Air Batteries that Employ Redox Active Composite Electrolytes

In a first embodiment, lithium-air batteries that employ redox active additive composite electrolytes are disclosed. Lithium-air batteries as illustrated in FIG. 22, employ a lithium anode that is electrochemically coupled to an oxidizing atmosphere such as by an air cathode. During discharge, Li+ ions flow from the Li anode through a redox active additive composite electrolyte to combine with oxygen at the cathode to form Li₂O or Li₂O₂. Flow of Li+ ions is coupled to flow of electrons from the anode to the cathode through an external load circuit. Lithium-air batteries that employ redox active additive composite electrolytes may show improved ionic current and coulombic efficiency compared to Lithium-air batteries that do not employ redox active additive composite electrolytes.

A variety of Lithium-air battery constructions may be formed with use of redox active additive composite electrolytes. The Lithium-air battery constructions employ a redox active additive composite electrolyte that includes one or more redox active additives and any of glass electrolytes, ceramic electrolytes, glass ceramic electrolytes and mixtures thereof. Examples of redox active additives that may be employed include but are not limited to Fe₂O₃, MoO₃, SnO₂, ZnO, Au, Pt and mixtures thereof.

Examples of ceramic electrolytes that may be employed in redox active additive composite electrolytes include but are not limited to (Li,La)TiO₃ (“LLTO”) type ceramic electrolytes such as Li₃ₓLa_{(2/3)-x}□_{(1/3)-2x}TiO₃ where □ represents vacancy sites and where 0<x<0.16, ((Li, La) (Ti, Zr, Hf))O₃ and mixtures thereof to enable improved ionic transfer number. ((Li, La) (Ti, Zr, Hf))O₃ type materials are made from standard solid state processes.

An ionically conducting ceramic, redox additive composite electrolyte may be made by forming a mixture of one or more ionically conducting ceramic materials with one or more redox active ceramic additives. The mixture is ground, dried, and fired to form an ionically conducting ceramic, redox additive composite electrolyte. The mixture may be random, uniform, non-uniform or graded through its thickness as described above.

Examples of glass electrolytes that may be employed in redox active additive composite electrolytes include but are not limited to Li phosphate glasses such as are not limited to Li(AlGeTi)(PO₄)₃, Li₁₊ₓAlₓGe₂₋ₓ(PO₄)₃ where 0<x<1.0, Li(AlGeTi,Hf)(PO₄)₃ and mixtures thereof. LiAlGe-Phosphate(“LAGP”) glasses may be formed from a mixture of Li+ precursor material such as Li₂CO₃, phosphate precursor such as NH₄H₂PO₄, Al₂O₃ as a glass modifier and a glass former such as Ge₂O₃. The mixture is ground to produce ground powder. The ground powder may be calcined at about 750° C. to about 850° C. for about 30 min to about 60 min to produce a calcined material. The calcined material again may be milled to produce milled material. The milled material may be melted at about 1200° C. to about 1400° C. for about 2 hrs to about 4 hrs to produce a melt. The melt may be quenched by casting onto motorized rollers at about 1400° C. to about 1100° C. to form glass sheets. The glass sheets then may be optionally annealed at about 450° C. to about 550° C. for about 1 hr to about 3 hr. and then cooled to room temperature at about 1° C./min to about 2° C./min to produce a cooled Li⁺ conducting phosphate germanium glass sheet. The Li⁺ conducting phosphate germanium glass may be crushed, milled and mixed with about 0.1 wt. % to about 40 wt. % of a redox active additive and ball milled in a lower alkanol such as ethanol to yield ground slurry. The ground slurry may be passed through a 300-mesh sieve to produce screened slurry that is dried at about 80° C. to about 120° C. form milled powder.

The milled powder is mixed with about 5 wt. % to about 20 wt. % binder and plasticizer in an amount of up to about 5 wt. %, all amounts based on the weight of the milled powder, to form a binder-powder mixture that is mixed with a solvent blend such as 50/50 MEK/ethanol to form slurry that may be cast into tape. Binders that may be employed include but are not limited to Poly Vinyl Butyral, Poly(propylene carbonate), polyvinyl alcohol and mixtures thereof. Plasticizers that may be used include but are not limited to di-octyl phthalate, butyl benzyl phthalate, propylene carbonate and mixtures thereof.

The cast tapes may be electroded such as by screen-printing thick film conductive ink such as platinum, gold or palladium silver on to the tapes. The resulting electroded tapes then may be aligned and laminated such as in an isostatic press at about 50° C. to about 80° C. at about 3000 psi to 4000 psi for about 10 min to about 30 min to produce a green laminate. The green laminate is fired at about 800° C. to about 1000° C. for about 1 hour to about 12 hours in order to form a ceramic, redox additive composite electrolyte.

Examples of chalcogenide type glass electrolytes that may be employed include but are not limited to Li— sulphides such as Li₂S—P₂S₅. Examples of glass ceramic electrolytes that may be employed include but are not limited to 70Li₂S-30P₂S₅. The 70Li₂S-30P₂S₅ glass ceramic electrolyte may be made by ball milling a mixture of reagent grade Li₂S and P₂S₅ in a molar ratio of 70Li₂S/30 P₂S₅ and to form an amorphous material. The amorphous material is heated to 200-300° C. for 2 h to form a glass-ceramic.

Li-Air batteries that employ Redox active composite electrolytes is further illustrated by the following non-limiting example:

### Example LA1

The composite electrolyte of Example LGC2 is used in a Li-Air battery configuration. Li foil (200 um thick) is used as anode and Pt coated carbon sheet as cathode. The electrolyte of example LGC2 that has a thickness of 200 um and diameter of 10 mm is imbedded between the anode and cathode to form a Li-air battery in the form of a coin cell that has net-shape holes on the cathode side to allow air flow. The anode is isolated from interaction with air using a high temperature wax.

Manufacture of Li-Air Batteries that Employ Redox Active Composite Electrolytes

Li-Air batteries that employ a redox active additive composite electrolyte may be formed by placing a redox active additive composite glass ceramic electrolyte membrane such as a LAGP glass ceramic electrolyte membrane between a Li foil as anode and a carbon layer as cathode.

Redox active additive glass ceramic electrolyte composite membrane for use in Li-air batteries may be made by a variety of methods such as casting and extrusion. For example, a frit of redox active additive composite ceramic electrolyte, a redox active additive doped ceramic glass electrolyte, or mixtures thereof may be admixed with a liquid vehicle such as water, lower alkanol or mixtures thereof to form a slurry that is tape cast. The cast tape then is dried and forms a tape. A multi-layer membrane may be produced by forming a laminate of two or more cast tapes that include redox active additive composite electrolytes and heat-treating the laminate. To illustrate, two or more layers of a composition that includes one or more redox active additives and a glass frit such as a Li-ceramic such as (LiLa)TiO₃ may be screened printed onto a ceramic tape or monolith, and stacked to form multilayer structure that then may be heat treated such as by a hot pressing and sintering processes to densify the laminate.

Primary and Secondary Li Ion Type Batteries that Employ Redox Active Additive Composite Electrolytes.

In another embodiment, primary lithium ion batteries and secondary lithium ion batteries that employ redox active additive Li ion conductive composite electrolytes are disclosed. Lithium ion batteries that include redox active additive composite electrolytes may be employed to support acute, high electrical current demands of devices such as digital cameras and may replace alkaline batteries. These types of batteries may be used in portable consumer electronic devices such as but not limited to implantable electronic medical devices such as artificial pacemakers, clocks, camcorders, digital cameras, thermometers, calculators, laptop BIOS, communications equipment and remote car locks.

Lithium ion batteries that employ redox active additive composite electrolytes may be employed in a variety of configurations such as 3-volt “coin” type lithium-manganese batteries that are typically about 20 mm in diameter and have a thickness of about 1.6 mm to about 4 mm thick.

Primary and Secondary Li-ion batteries that employ Redox active composite electrolytes are further illustrated by reference to the following non-limiting examples

### Example LP1

The membrane of Example P1 is used in a Lithium-ion Primary battery. The battery includes a lithium metal anode and a manganese dioxide cathode. The battery is assembled in a coin cell architecture. Manganese dioxide powder is mixed with acetylene black and Teflon binder in the ratio 85:5:10 by mass. This mixture is formed into a paste and rolled to a thickness of 100 microns. A 0.635 inch diameter circle is punched from the rolled paste and dried under vacuum for 24 hrs to form the cathode electrode. The cathode electrode is transferred to a glove box where it is placed into the coin cell casing. A few drops of electrolyte (EC:DMC(50:50 wt), 1M LiPF₆) is added to the cathode electrode. The membrane of example P1 is soaked in this electrolyte and placed on top of the cathode. Finally, a lithium anode formed by pressing lithium metal onto a copper current collector to form an anode that has a thickness of 40 microns is placed on top of the membrane. The coin cell is then crimped in order to form a primary Li-ion battery.

### Example LS1

### Li-Ion Secondary Battery

The procedure of Example LP1 is followed except that the cathode material manganese dioxide is replaced by LiCoO₂.

### Example LS2

### Li-Ion Secondary Battery

The procedure of Example LP1 is followed except that the cathode material manganese dioxide is replaced by lithium manganese oxide.

### Example LS3

### Li-Ion Secondary Battery

The procedure of Example LP1 is followed except that the cathode material manganese dioxide is replaced by LiFePO₄.

Primary Li-Ion Batteries that Employ Redox Active Additive Li Ion Conductive Composite Electrolytes.

Primary Lithium batteries that may utilize redox active additive Li ion conductive composite electrolytes may employ an anode that includes any one or more of lithium metal, lithium compounds such as lithium halides such as lithium thionyl chloride, lithium bromine chloride, lithium iodine and mixtures thereof, lithium sulfur dioxide and mixtures thereof, a membrane that includes redox active additive lithium conductive composite electrolytes, and a cathode that includes MnO₂, MoO₃ and mixtures thereof.

Primary Li-ion batteries that employ a membrane that includes redox active additive Li ion conductive composite electrolytes may show greater power densities compared to primary Li-ion batteries that do not employ Li ion conductive composite electrolytes. For example, a lithium manganese dioxide primary battery that employs a Li metal anode, a manganese dioxide cathode and a membrane that includes a redox active additive and composite electrolyte where MoO₃ is employed as a redox active additive and PVDF-HFP as electrolyte may show improved power density and specific capacity.

Electrolytes that may be employed with redox active additives for use in redox active additive composite electrolytes in primary lithium batteries include but are not limited to lithium perchlorate in propylene carbonate; lithium tetrachloroaluminate in thionyl chloride; lithium bromide in a mixture of sulfur dioxide and acetonitrile; lithium tetrafluoroborate in propylene carbonate; lithium tetrafluoroborate in dimethoxyethane; lithium tetrafluoroborate in gamma-butyrolactone; organic charge transfer complexes such as poly-2-vinylpyridine(P₂VP), lithium hexafluorophosphate in a blend of propylene carbonate and dimethoxyethane, lithium hexafluoroarsenate in a blend of propylene carbonate and dimethoxyethane and mixtures thereof.

Redox active additives for use in in redox active additive composite electrolytes for use primary lithium batteries include but are not limited to MoO₃, Au, Pt, SiO₁₋ₓ where 0.1x<1.5, MnO₂, FeO and mixtures thereof. Redox active additives employed may be in the form of particles, rods, mesh and rods and combinations thereof. The redox active additives may be in contact with each other and also may be isolated from each other within an electrolyte. Redox active additives may be present in a redox active additive composite electrolyte for use a primary lithium battery in an amount sufficient to achieve high energy density and high power density. Redox active additives may be present in an amount of about 0.05% to about 50% based on the weight of the electrolyte.

Primary Li ion batteries that employ redox active additive composite electrolytes may be made by methods described in US 2009/0123844, the teachings of which are incorporated by reference by their entirety herein.

Secondary Li-Ion Batteries that Employ Redox Active Additive Li Ion Conductive Composite Electrolytes.

In another embodiment, secondary lithium ion batteries that include an anode, a cathode and a redox active additive composite electrolyte are disclosed. Secondary lithium-ion batteries that employ redox active additive composite electrolytes may be employed in a wide variety of consumer electronics and electric vehicles. Secondary lithium-ion batteries that employ redox active additive composite electrolytes may show much higher energy densities, improved coulombic efficiencies, and improved resistance to fading effects, and reduced self-discharge when not in use compared to secondary lithium ion batteries that that do not employ redox active additive composite electrolyte.

Polymeric electrolytes that may be employed in redox active additive composite electrolytes for use in lithium-ion secondary batteries include but are not limited to PVDF, PEO and mixtures thereof. Redox active additives that may be employed in redox active additive composite electrolytes for use in secondary lithium-ion batteries include but are not limited to MoO₃, FeO, Fe₂O₃, V₂O₅, SnO₂, Au, Pt and mixtures thereof. Redox active additives may be present in an amount of about 0.05 wt. % to about 50 wt. %, preferably about 1 wt. % to about 10 wt % based on the weight of the electrolyte.

Materials that may be employed as anodes in secondary lithium ion batteries that employ a redox active additive composite electrolyte include but are not limited to Li, lithiated carbon, Li-titanate and mixtures thereof. Materials that may be employed as cathodes in secondary lithium ion batteries that employ a redox active additive composite electrolyte include but are not limited to carbon, LiCoO₃₋ₓ where 0<x<1, LiFePO_{4-y} where 0<y<1 and mixtures thereof. Secondary Li ion batteries that employ redox active additive composite electrolytes may be made by methods such as disclosed in US Published Patent Appl. 2010/0129719, the teachings of which are incorporated herein by reference in their entirety.

High Temperature Batteries and High Temperature Capacitors that Employ Redox Active Additive Composite Electrolytes

In another embodiment, high temperature batteries and high temperature capacitors such as high temperature supercapacitors that typically operate at about 20° C. to about 250° C. and that employ redox active additive composite electrolytes are disclosed. High temperature batteries and capacitors that employ redox active additive glass ceramic composite electrolytes may sustain higher voltages and/or current to enable increased energy density and power density compared to high temperature batteries and capacitors that do not employ redox active additive composite electrolytes.

Redox active additive composite electrolytes that may be employed in high temperature batteries and high temperature capacitors include but are not limited to redox active additive glass ceramic composite electrolytes. Redox active additive ceramic glass composite electrolytes employed in high temperature batteries or high temperature capacitors may vary in thickness from about 1 mm to about 1.0 μM.

Glass ceramic electrolytes that may be employed with redox active additives for use in high temperature batteries and high temperature capacitors include but are not limited to LAGP-based glass ceramics such as LiAlGe-phosphate glass ceramics, tellurium based glass ceramics such as Li₂S—P₂O₅—TeO₂, selenium based glass ceramics such as chalcogenide sulphide glass ceramics such as Li₂S—P₂S₅ and mixtures thereof.

Redox active additives that may be employed with glass ceramic electrolytes for use in redox active additive glass ceramic composite electrolytes for use in high temperature batteries include but are not limited to Pt, Au, MoO₃, WO₃, SnO₂, LiTiO3 and mixtures thereof.

### Manufacture of High Temperature Batteries and Capacitors

Cathode and anode electrodes for use in high temperature batteries and capacitors that employ redox active additive composite electrolytes may be screen-printed onto a redox active additive ceramic glass composite. The electrodes may be screen printed such as in the form of organic ink, as a thick film frit or combinations thereof. The electrodes also may be deposited as a thin film such as by chemical vapor deposition.

A redox active additive composite electrolyte membrane for use in high temperature batteries and capacitors may formed by laminating a stack of cast tapes formed from slurries of redox active additive composite electrolyte. The surface area of the electrolyte may be increased by incorporating a fugitive material into top and bottom layers of a stack. The fugitive material may include but not limited to carbon, starch and mixtures thereof. The fugitive material is incorporated into the slurries employed to form the top and bottom layers of the stack. During heat treatment, the fugitive material is vaporized to impart increased porosity to enhance the bonding of electrodes to the redox active additive composite electrolyte membrane

An anode material such as Li metal, Li-glass such as LAGP, Li-glass frit such as LiBO borate and mixtures thereof may be formed onto a porous surface of a redox active additive composite electrolyte membrane by placing the anode material in contact with porous surfaces of the composite electrolyte membrane and then heating the anode material to above its melting point. The molten anode material then may flow into and bond with porous surfaces of the composite electrolyte membrane. Similarly, Li containing cathodes such as LiCoO₃, LiFePO₄ and mixtures thereof may be formed on porous surfaces of an electrolyte such as a ceramic-glass electrolyte.

### High Temperature Supercapacitors

In another embodiment, high temperature supercapacitors that operate at about −50° C. to about 400° C. are disclosed. The high temperature supercapacitors may employ a redox active additive composite electrolyte, a cathode mixture that includes electrode blocking metal powder and Li-glass frit, and an anode formed from carbon, Li-metal, LiTiO and mixtures thereof. Glass ceramic electrolytes that may be employed with redox active additives in a redox active additive composite electrolyte include but are not limited to LAGP-based glass ceramics, chalcogenide selenium based glass ceramics, tellurium glass ceramics and mixtures thereof. LAGP-based glass ceramics that may be employed include but are not limited to LiAlGe-phosphate glasses, LiAlGeTi phosphate glasses and mixtures thereof. Chalcogenide selenium glass ceramics that may be employed include but are not limited to Li₂S—P₂S₅.

Redox active additives that may be employed in redox active additive glass ceramic composite electrolytes include but are not limited to MoO₃, MnO₂, TiS₂, Li₂S and mixtures thereof. The amount of redox active additive is sufficient to achieve capacitive enhancement. Typically, the amount of redox active additive is about 0.05 wt. % to about 50 wt. % based on the weight of the glass ceramic electrolyte.

Blocking metal powders for use in a cathode mixture include but are not limited to Ni, Cu, W, Ta, Nb, Fe—Cr—Ni, alloys thereof and mixtures thereof. Li-glass frits for use in a cathode mixture include but are not limited to Li-Borate. Blocking metals may be present in the cathode mixture in an amount of about 40 wt. % to about 95 wt. % based on the weight of the Lithium glass frit. Carbon additives such as graphite and carbon black also may be added to the cathode mixture employed to reduce oxidation during heat treatment. Where carbon additives are employed in the cathode mixture, the additives may be included in an amount of about 1 wt. % to about 10 wt. % based on the combined weight of blocking metal and frit. The mixture of blocking metal and frit, optionally with carbon additive, may be heated in a controlled atmosphere such as N₂—H₂, or argon to minimize oxidation;

High temperature supercapacitors that employ a redox active additive composite electrolyte may be made according to the procedures shown in US 2009/0214957 and US 2010/004095, the teachings of which are incorporated herein by reference in their entirety. High temperature supercapacitors that employ redox additive composite electrolytes is further illustrated by the following non-limiting examples:

### Example LG1

### Li+ Conducting LAGP-Au Redox Additive Composite Electrolyte

Stoichiometric amounts of Li₂CO₃, Al₂O₃, Ge₂O₃ and H₄H₂PO₄ are mixed by ball milling in ethanol. The mixture is dried, ground into powder and then calcined at 750° C. for 1 h. The synthesized powder is then reground to produce a milled powder. The milled powder is melted at 1300° C. for 2 h. The melt is quenched by casting onto motorized rollers to form glass sheets. The glass sheets are annealed at 500° C. for 1 h, and then cooled to room temperature at 1° C./min to produce a Li⁺ conducting LAGP. The LAGP glass is crushed, milled and mixed with 5 wt % of Au redox active additive Au and ball milled in ethanol. The milled powder is mixed with 5 wt. % polyvinyl-butryl binder and 1 wt % dibutyl phthalate plasticizer in ethanol to form a slurry that is cast into tape. The cast tape is fired at 850° C. for 4 h in order to form a redox additive composite.

### Example LG2

### Li+ Conducting LAGP-SnO₂ Redox Additive Composite Electrolyte

The procedure of example LG1 above is employed except that SnO₂ is substituted for Au.

### Hybrid Battery-Capacitors Having Redox Active Additive Composite Electrolyte

In another embodiment, hybrid battery capacitors such as Li-intercalated battery-capacitors that employ a redox active additive composite electrolyte membrane are disclosed. A hybrid battery capacitor that employs a membrane that includes a redox active additive composite electrolyte such as any one or more of redox active additive composite polymer electrolytes and redox active additive glass ceramic electrolytes may be charged in shorter time periods, may be discharged over shorter time periods, and may show improved energy storage and power density compared to prior art supercapacitors or batteries.

A hybrid battery capacitor that employs a membrane that includes a redox active additive composite electrolyte may show a very rapid initial discharge rate characteristic of a capacitor followed by a relatively slow discharge rate characteristic of a battery. The voltage output of a hybrid battery-capacitor device that employs a redox active additive composite electrolyte may vary from about 1V to about 7V, preferably from about 1V to about 5.5 V.

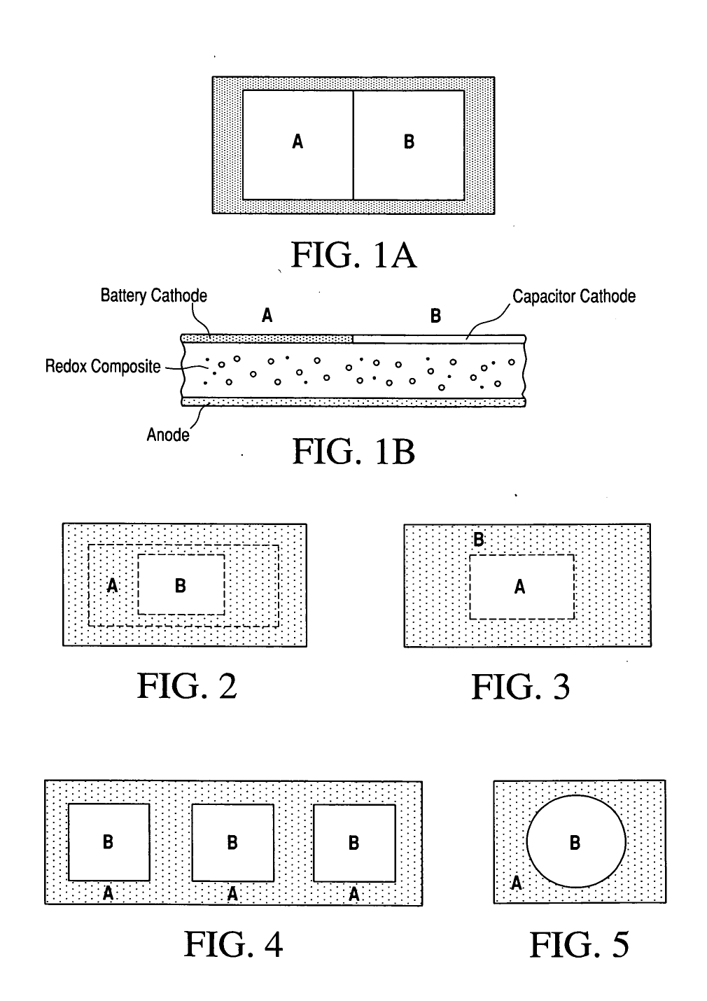

A hybrid battery-capacitor as illustrated in FIGS. 1A,1B, includes a continuous anode, a multi-sectional cathode and an intermediate redox active additive composite electrolyte. The electrolyte contacts both the anode and the multi-sectional cathode. The anode includes a Li ion source and is capable of reversible redox reactions. The multi-sectional cathode, as also shown in FIG. 1B, includes cathode sections (A) and (B). Battery cathode section (A) contacts a first portion of the composite redox active additive composite electrolyte so that the battery-capacitor may discharge in a manner characteristic of a battery. Capacitor cathode section (B) contacts a second portion so that the battery capacitor may discharge in the manner of a capacitor. Cathode sections (A) and (B) may be in contiguous contact and or with a separation with gaps between materials from 0 which is the contiguous case up to millimeters. Cathode section (A) preferably is LiCoO₃ and cathode section (B) preferably is carbon.

Electrolytes that may be employed in redox active additive composite electrolytes include but are not limited to glass ceramic electrolytes, polymeric electrolytes and mixtures thereof. Glass ceramic electrolytes that may be employed include but are not limited to Li₂S—Li₂P, LAGP and mixtures there. Polymeric electrolytes that may be employed include but are not limited to PVDF, PEO and mixtures thereof. Where glass ceramic electrolytes are employed, the redox active additive typically is present in the glass ceramic electrolyte in an amount of about 0.1 wt. % to about 40 wt. % based on the weight of the glass ceramic electrolyte. Where polymeric electrolytes are employed, the redox active additive typically is present in the polymeric electrolyte in an amount of about 0.1 wt. % to about 30 wt. % based on the weight of polymeric electrolyte.

Hybrid Battery-Capacitors Having Redox Active Additive Composite Electrolyte are further illustrated by the following non-limiting example:

### Example HB1

### Hybrid Battery-Capacitor with Li⁺-PVDF-LiₓCoO₂ and MoO₃₋ₓ Redox Additive Composite Electrolyte Membrane

The composite electrolyte separator membranes of examples P7 (Li⁺-PVDF-LiₓCoO₂) and P8 (Li⁺-PVDF-MoO₃₋ₓ) of 150 μm thickness are aligned on a lithiated carbon anode electrode. Activated Carbon paste for the capacitor section of the hybrid battery-capacitor and LiFePO₄ paste for the battery section of the hybrid battery-capacitor are screen-printed to form multi-sectional cathode patterns on a current collector metal foil. The screen printed metal foil is combined with the membranes in order to form a hybrid battery-capacitor.

### Multi-Sectional Cathodes

Materials that may be employed in battery cathode section (A) of a multi-sectional cathode include but are not limited to LiCoO₃, LiVOx where 0<x<3, Li₂Ti₄O₁₂ (“LiTiO”), LiFePO₄ and mixtures thereof. Materials that may be employed in capacitor cathode section (B) of a multi-sectional cathode include but not limited to carbon, metals such as Ta, Fe, Ni, alloys thereof, intermetallics thereof and mixtures thereof. Capacitor cathode section (B) may have an enhanced surface area to enable increased electrical double layer capacitance.

As shown in FIG. 1A, battery cathode section (A) of multi-sectional cathode A-B may be employed as a battery cathode. Battery cathode section (A) of multi-sectional cathode A-B may include LiVO, LiCoO₂, LiMn₂O₃ and mixtures thereof. In FIG. 1A, capacitor section (B) of multi-sectional cathode A− may be formed of a material such as carbon, carbon nanotubes, blocking metal foils such as Ta, blocking metals such as Fe, Fe—Cr—Ni, Ta, W and mixtures thereof.

Multi-sectional cathodes that employ Redox active composite electrolytes is further illustrated by the following non-limiting example:

### Example MSC1

### Casting Battery Cathode-LiMn₂O₄ and Capacitor Cathode-AC

1:4 molar ratio of Li₂CO₃ and MnO₂ precursors is mixed by ball milling in ethanol. The mixture is dried, ground into powder and then calcined at 650° C. for 8 h. The synthesized powders are then reground. LiMn₂O₄ spinel may be obtained by heat treatment at 750° C. for 20 h in air. The LiMn₂O₄ and AC (activated carbon) pastes with 10 wt. % Teflon binder are cast by screen-printing onto a copper metal foil current collector to form a multi-sectional cathode electrode. The multi-sectional cathode electrode sheet is dried at 120° C. under vacuum for 48 hours for use as a cathode electrode in a hybrid battery-capacitor.

### Example MSC2

The procedure of example MSC1 is followed except that aluminum is substituted for the copper foil.

### Electrode Configurations for a Hybrid Battery Capacitor.

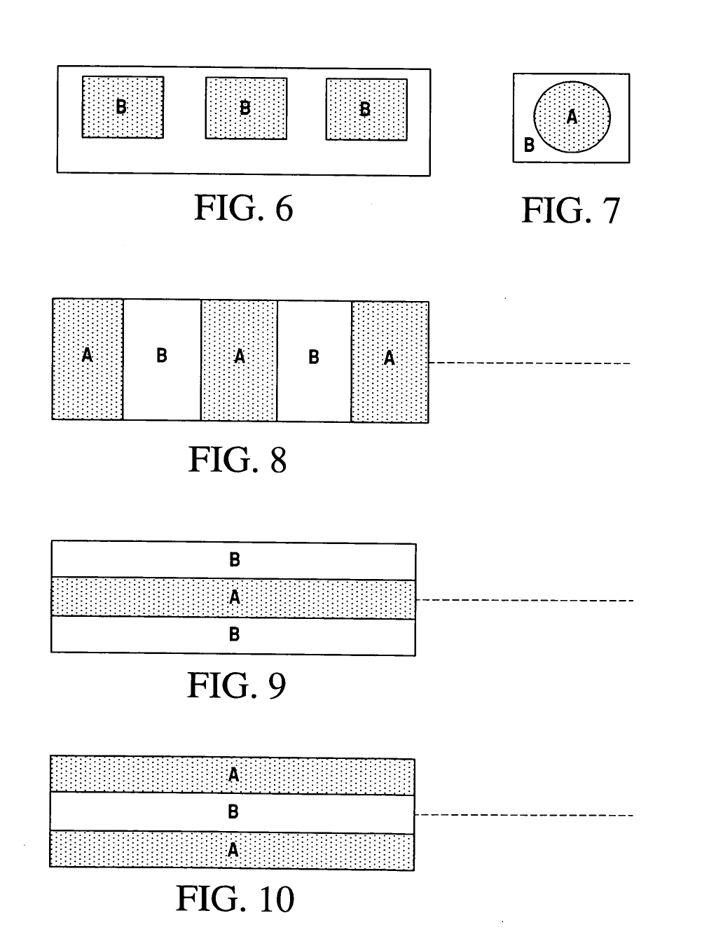

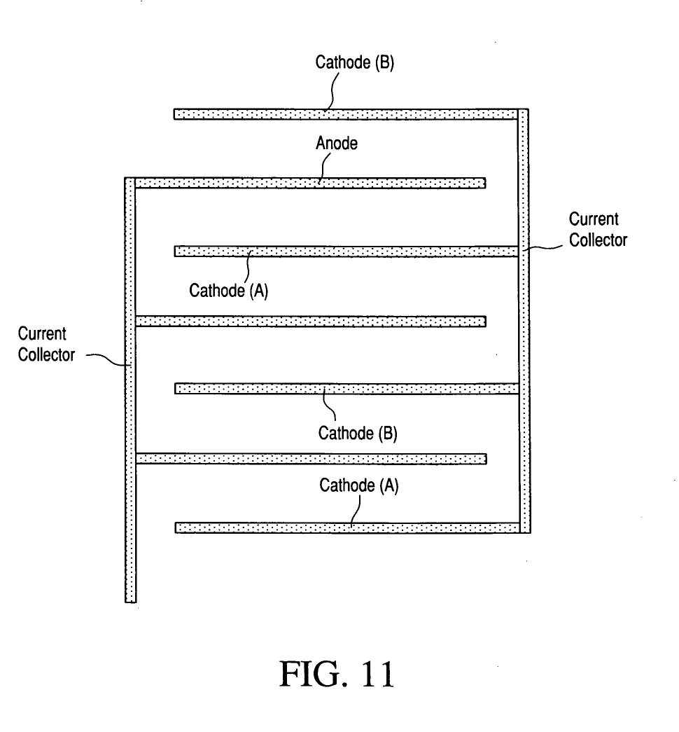

FIGS. 2 to 10 show, illustrative but non-limiting electrode configurations that may be utilized in a hybrid battery capacitor that employs a redox active additive composite electrolyte. FIG. 11 shows a multilayer configuration of a hybrid battery-capacitor.

Hybrid battery capacitors that employ redox active additive composite electrolyte may be made by applying a continuous anode to a first side of a redox active additive composite polymer electrolyte membrane. Battery section cathode and cathode section anode may be applied to the opposite side of the membrane.

Redox active additive composite polymer electrolytes suitable for use in hybrid-battery capacitors may be processed into a membrane by casting one or more tapes of redox active additive composite polymer electrolyte. The tapes may be formed into stack of the tapes that then may be heat treated to produce to produce a membrane. Alternatively, a single tape may be heat treated to produce a membrane. Where a plurality of tapes is employed in a stack, the tapes employed in the stack may utilize the same or different polymeric electrolytes.

A first side of the membrane may be coated with an anode material. Coatings of anode material may be formed by a variety of known methods such as chemical vapor deposition, sputtering, silk screen printing and combinations thereof. A first portion of the opposite side of the membrane may be coated with battery cathode material and another section of that opposite side of the membrane may be coated with capacitor cathode material. Coatings of cathode material may be formed by a variety of known methods such as chemical vapor deposition, sputtering, silk screen printing and combinations thereof.

Protonic Supercapacitors that Employ Membranes Formed of Redox Active Additive Composite Polymer Electrolytes

In another aspect, protonic supercapacitors that employ a redox active additive composite polymeric electrolyte, anode and cathode are disclosed. These protonic supercapacitors may achieve improved energy storage compared to protonic supercapacitors that do not employ redox active additive composite polymeric electrolytes.

Polymer electrolytes that may be employed in redox active additive composite polymer electrolytes include but are not limited to Nafion, polyvinyl alcohol, polybenzimidazole, polyacrylic acid and mixtures thereof. Redox active additives that may be employed in a redox active additive polymer electrolyte include but are not limited to MnO₂₋ₓ where 0<x<0.2, RuO₂₋ₓ where 0<x<0.2, double layer hydroxides (DLH) such as cobalt hydroxide, nickel aluminum hydroxide, cobalt aluminum hydroxide, cobalt chromium hydroxide, nickel chromium hydroxide and mixtures thereof. Redox active additives employed may have various morphologies such as whiskers, tubes, spheres, platelets and mixtures thereof. The redox active additives also may be integrated and deposited into meshes that are embedded and surrounded by the electrolyte. Redox active additives may be employed in redox active additive composite polymeric electrolytes in an amount of about 0.01 wt. % to about 50 wt. % based on the weight of polymeric electrolyte.

Protonic supercapacitors that employ membranes formed of redox active additive composite polymeric electrolytes may be made according to procedures disclosed U.S. Pat. No. 5,136,474, the teachings of which are incorporated herein by reference in their entirety. Protonic supercapacitors that employ membranes formed of redox active additive composite polymer electrolytes, are further illustrated by reference to the following non-limiting procedures:

Procedure A:

Symmetric electrochemical capacitors that employ activated carbon (about 100 um thick) as positive and negative electrodes are sandwiched together using a polymer composite membrane that has a thickness of about 20 um to about 50 um. The polymer membrane may be formed by tape casting a mixture of proton conducting polymers such as but not limited to Nafion, sulfonated polyetheretherketones, polyvinyl alcohol hydrogels, polymethylmethacrylate, and combinations thereof, and redox active fillers such as one or more of metal oxides which have about 1 wt % to about 50 wt % of manganese dioxide, molybdenum oxide, iron oxide, one or more of layered double hydroxides such as Co(OH)₂, cobalt aluminum hydroxide, nickel aluminum hydroxides or mixtures thereof with one or more conducting polymers such as but not limited to polyaniline, polypyrrole, PEDOT mixtures thereof. Typically, a slurry of about 85 wt % activated carbon, about 10% Teflon and about 5 wt % acetylene black is mixed together using tetrahydrofuran as solvent. The resultant mixture is applied onto thin carbon paper, dried and used as electrodes. Then, about 5 g of polyvinylalcohol is dissolved in about 20 ml of water to form a solution, and about 5 wt % polyaniline based on the weight of polyvinyl alcohol is added to the solution. Then, about 2 wt % of glutaraldehyde (crosslinking agent) is added to the solution based on wt. of polyvinylalcohol. The resulting solution is tape cast to a thickness of about 20 um to about 50 um to form a membrane. The tape cast membrane is dried and soaked in about 1M sulfuric acid overnight to form a soaked, composite membrane. A symmetric capacitor such as in a 2032 stainless steel coin cell or a Teflon Swagelok cell may be made by laminating the carbon electrodes with the soaked composite membranes.

Procedure B:

Asymmetric electrochemical aqueous capacitors that employ activated carbon as negative electrode and any one or more of manganese dioxide, nickel hydroxide or lead dioxide as the positive electrode are laminated with a polymer composite membrane made from proton conducting polymers such as any one or more of Nafion, sulfonated polyetheretherketones, polyvinyl alcohol hydrogels, polymethylmethacrylate together with any one or more of redox active fillers such as metal oxides that have about 1 wt % to about 50 wt. % of any one or more of manganese dioxide, molybdenum oxide, iron oxide or any one or more of layered double hydroxide such as Co(OH)₂, cobalt aluminum hydroxide, nickel aluminum hydroxides with any one of the conducting polymers such as but not limited to polyaniline, polypyrrole or PEDOT.

Typically, a slurry of about 85 wt % activated carbon, about 10% Teflon and about 5 wt % acetylene black is mixed together using tetrahydrofuran (THF) as solvent. The mixture is applied onto thin carbon paper, dried and used as negative electrodes.

Similarly, a slurry containing about 70 wt % MnO₂, about 20 wt % acetylene black and about 10 wt % Teflon is dissolved in THF and applied onto a carbon paper. The dried paper is used as the positive electrode. The ratio of weight of the positive and negative electrodes may vary from about 1:1 to about 3:1 respectively. Then, about 5 g of polybenzimidazole is dissolved in Dimethylformamide under reflux conditions overnight to form a solution to which is added about 5 wt % cobalt hydroxide based on the weight of polybenzimidazole to form a polymer solution. The polymer solution is tape cast to form a membrane of about 20 um to about 50 um thickness. The cast membrane is dried and soaked in about 4M KOH overnight in order to form a soaked, composite membrane. An asymmetric capacitor in a 2032 stainless steel coin cell or a Teflon Swagelok cell may be made by laminating the positive and negative electrodes with the soaked composite membranes.

### Li-Ion Capacitors Having Redox Active Additive Composite Electrolytes

In another aspect, Li-ion capacitors that employ redox active additive composite electrolytes are disclosed. These capacitors may achieve significant increases in output voltage and capacitance. Li-ion capacitors that utilize redox active additive composite electrolytes may employ a cathode that may include activated carbon and an anode that may include Li metal, lithiated graphite, lithium titanate, silicon, gold, tin and mixtures thereof.

Polymeric electrolytes that may be employed in redox active additive composite electrolytes for use in lithium ion capacitors include but are not limited to PVDF, HFP, PEO, mixtures thereof and copolymers thereof. Redox active additives that may be employed in the redox active additive composite electrolytes include but are not limited to MoO₃, MnO₂, SnO, ZnO and mixtures thereof. The amount of redox active additive in a redox active additive composite polymeric electrolyte typically is about 0.05 wt. % to about 50 wt. % based on the weight of the polymeric electrolyte. Li-ion Capacitors Having Redox Active Additive Composite Electrolytes may be made according to procedures disclosed in US20080094778 and U.S. Pat. No. 7,817,403, the teachings of which are incorporated herein by reference in their entirety.

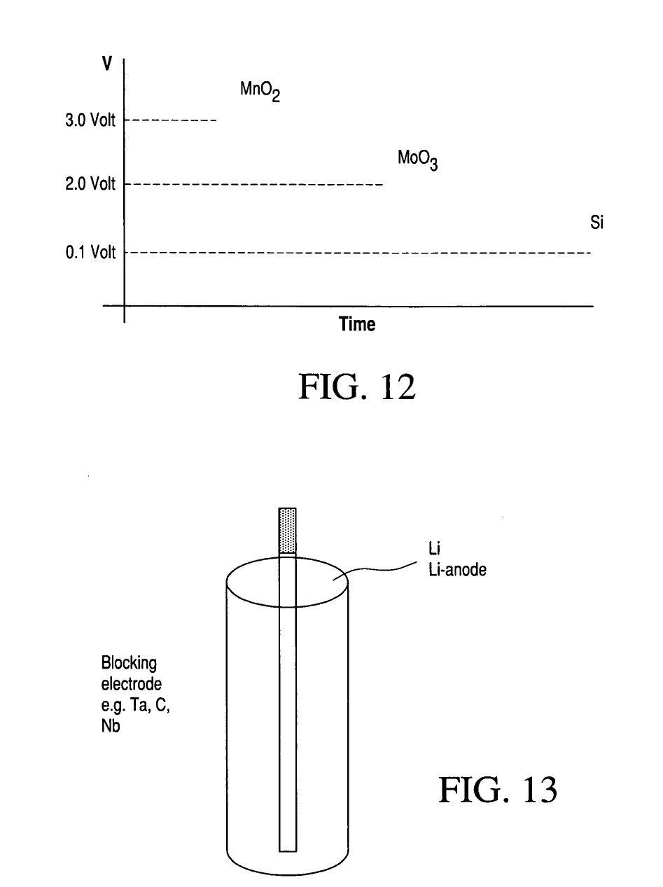

FIG. 12 shows charge behavior of Li-ion capacitors that employ Li metal as an anode, carbon as a cathode and a PVDF polymeric electrolyte that includes various MnO₂, MoO₃, and Si as redox active additives. MnO₂ has a redox potential of 3 volts and is present in the PVDF polymer in an amount of 5 wt. % based on the weight of the PVDF polymer; MoO₃ has a redox potential of 2 volts and is present in an amount of 5 wt. % based on the weight of the PVDF polymer, and Si has a redox potential of 0.1 volts and is present in the PVDF polymer an amount of 5 wt. % based on the weight of the polymer. The anode, cathode and redox active additive polymeric electrolyte are packaged in a glove box environment and assembled into coin cells. The charge behavior of the cells is determined by constant current charge/discharge method by use of standard potentiostats from Gamry Corporation.

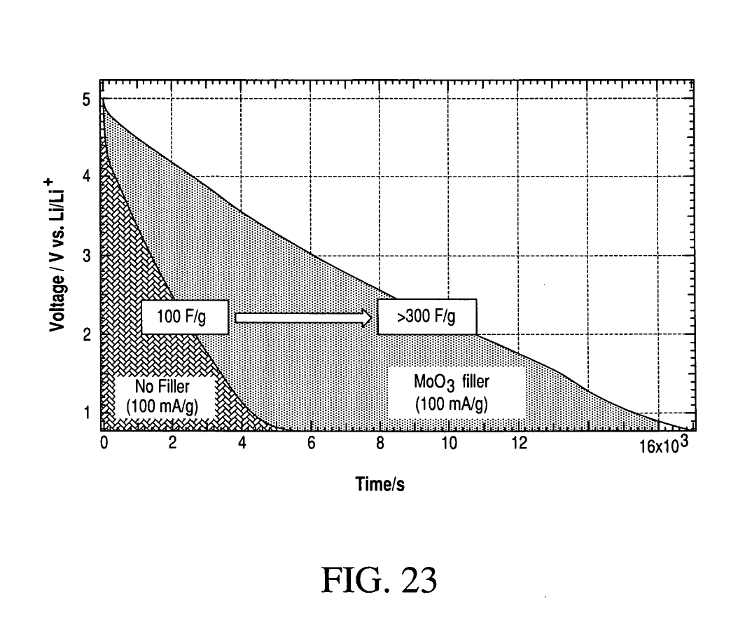

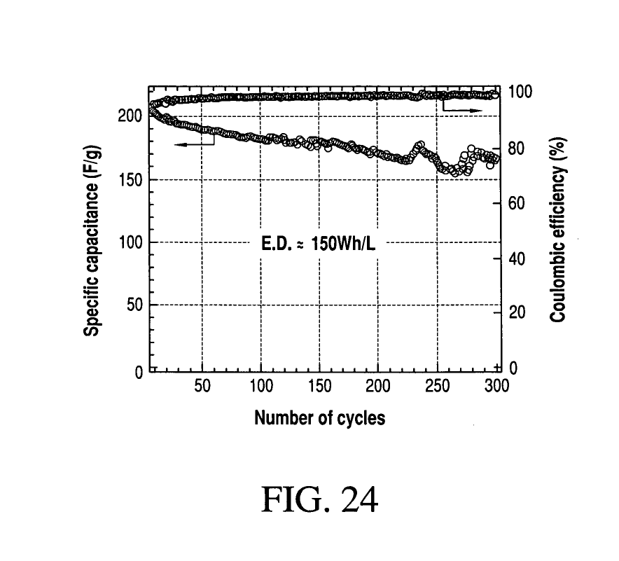

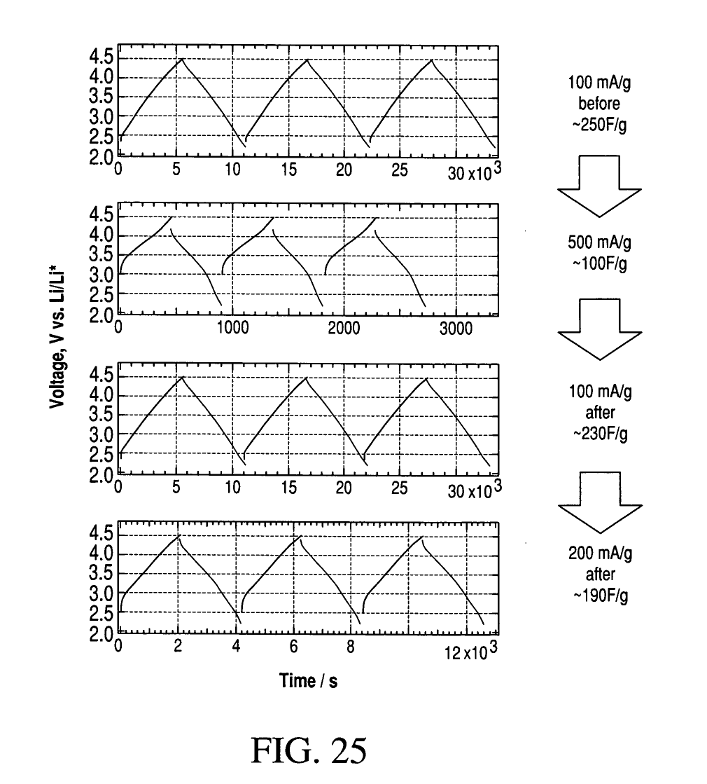

Lithium ion capacitors that employ activated carbon as positive electrode and any one or more of lithium, lithium titanate, lithium doped graphite, lithium doped silicon as negative electrode is further illustrated below. The electrodes are laminated with a polymer composite membrane formed from polymer gels such as any one or more of polyvinylidene fluoride, polyvinylidene fluoride-co-hexafluoropropylene, polymethylmethacrylate and polyacrylonitrile together with about 5 wt % to about 20 wt. % redox fillers such as any one or more of molybdenum oxide, tin oxide, vanadium oxide and manganese dioxide. For example, activated carbon electrode is made by kneading a mixture of 85 wt % activated carbon, 10 wt % Teflon and 5 wt % acetylene black. The mixture is roll pressed onto an aluminum foil for use as positive electrode (100 um in thickness). A small amount of lithium is pressed onto 25 um thick copper foil for use as negative electrode. Then, 5 g of PVDF-HFP is dissolved in 20 ml of DMF and allowed to stir overnight to form a polymer solution. 5 wt % of MoO₃ (based on the weight of PVDF-HFP) is added to the polymer solution and ultrasonicated. The resultant solution is tape cast to form a membrane and dried for 4 hours before subjecting to phase inversion using copious amount of ethanol. The cast membrane is then peeled and dried under vacuum. The treated membrane is then soaked in 1M LiPF₆/EC/DMC for 2 days to form a soaked membrane. A Lithium ion capacitor is assembled by sandwiching the positive and negative electrode with the soaked membrane. Performance of the capacitor is illustrated in FIGS. 23 to 25. FIG. 23 compares the constant current discharge curves for a capacitor made using a membrane treated with MoO3 redox active additive electrolyte compared to a membrane that was not treated redox active electrolyte. The capacitance, as shown in FIG. 23, increased by a factor of 3 under similar discharge rates. The cycling stability of the capacitor is shown in FIG. 24, and the charge-discharge curves of the capacitor shown in FIG. 25. The capacitor shows a capacitance of 250 F/g initially, and is then subjected to a short burst of high current cycling. Subsequently, when the capacitor is re-measured at a current of 100 mA/g the capacitance is only slightly reduced.

### Non-Planar, Li-Ion Hybrid Composite Membranes

In another embodiment, non-planar lithium ion hybrid composite membranes that employ redox active additive composite electrolytes are disclosed. Non-planar lithium ion hybrid composite membranes include but are not limited to cylindrical Li-ion hybrid composite membranes such as shown in FIG. 13.

FIG. 13 shows a cylindrical Li-ion hybrid composite membrane that employs an inner cathode, an outer anode and an intermediate redox active additive composite electrolyte. Electrolytes that may be employed in a redox active composite electrolyte include but are not limited to Fe₂O₃ and SiOₓ where 0.1<x<1.0. Redox active additives that may be employed in a redox active composite electrolyte include but are not limited to MoO₃. The amount of redox additive in the electrolyte typically is about 0.01 wt. % to about 50 wt. % based on the weight of the electrolyte. Non-Planar, Li-Ion Hybrid Composite Membranes may be made according to procedures disclosed in U.S. Pat. No. 6,426,863, the teachings of which are incorporated herein by reference in their entirety.

Membranes that employ redox active additive polymeric composite electrolytes may be employed in a variety of applications such as but are not limited to super-capacitors, ultracapacitors, primary batteries, secondary batteries, fuel cells, ionic separation membranes, gas separation membranes, chemical sensors and de-salination membranes. Polymeric electrolytes that may be employed in a redox active additive composite electrolyte, noting the fillers can be distributed homogeneously and non-homogeneously include but are not limited to polymers such as PVDF, PEO and mixtures thereof and may be employed with compatible electrolytic salts and solvents.

Redox active additives that may be employed in an electrolyte such as a polymeric electrolyte include but are not limited to MnO₂, FeO, NiO, Si, SnO₂, MoO₃ Au, Pt and mixtures thereof. Redox active additives may be present in an electrolyte in an amount sufficient to cause enhanced ionic conductivity, and modified space charge distributions one or more of the electrolyte and at the electrodes. Typically, redox active additives may be present in the electrolyte in an amount of about 0.01 wt. % to about 99.9 wt. % based on the weight of the electrolyte, preferably about 0.1 wt. % to about 50 wt. %, more preferably about 1 wt. % to about 15 wt. %. The redox active additives may be surrounded by electrolyte and isolated from the cathode and anode. Redox active additives may vary in size from about 0.1 nm to about 1 mm and may have a wide variety of configurations such as dodecahedron, cuboids, irregular polyhedral, platelets, rods, whiskers, cylinders, and mixtures thereof.

The redox active additives may be randomly distributed as a single type of configuration in the electrolyte, may be of mixed configurations and randomly distributed, may be mixed of mixed configurations and coated on to a surface of another active phase such as Pt on MoO₃. The redox active additives also may be aligned parallel or perpendicular relative to an electrode across the electrolyte, this could be aided with electric fields and or magnetic fields depending on the electrical characteristics of the redox filler inclusion. The redox active additives also may be layered in series with the electrode. Where redox active additives are in the form of rods of about 1 nm to about 10 μm in length or have a diameter of about 0.1 nm to about 1 μm, the rods typically have a porosity of about 0% to about 90%. Where redox active additives are in the form of platelets, the platelets may have a width of about 1 nm to about 100 μm and a thickness 1 nm to about 1 μm, and a porosity of 0% to about 90%.

Manufacture of Membranes that Include Redox-Active Additive Composite Electrolytes

Redox-active additive composite electrolytes such as redox-active additive polymeric electrolyte may be formed into tapes by methods such as casting and extrusion. The tapes typically have a thickness of about 0.1 μm to about 1000 μm, preferably about 10 μm to about 400 μm.

Membranes that include redox active additive composite electrolytes may be made by stacking layers of redox active additive composite electrolyte tapes and compressing the stack to form a membrane. As an illustration, redox active Fe₂O₃ particles of 1 nm diameter are mixed with Fe₂O₃ rods of 10 nm diameter, 1.0μ length to form a blend. The blend then is admixed with PVDF polymeric electrolyte to form a mixture. The mixture may be cast such as by tape casting or extrusion to form a membrane. Casting may be performed under a strong magnetic field, a strong electrical field or combinations thereof. Where electric fields are employed, the strength of the electric field is sufficient to cause redox active additives to align with the direction of the applied electric field. Any one or more of AC and DC fields that have field strength of about 0.1 kV/cm to about 10 kV/cm may be applied. Where magnetic fields are applied to redox active additives such as those that have diamagnetic anisotropy such as Fe₂O₃, NiO and mixtures thereof, the strength of the field is sufficient to cause redox active additives to align with the direction of the applied magnetic field. Typically, magnetic fields that may be employed have strength of about 100 gauss or more

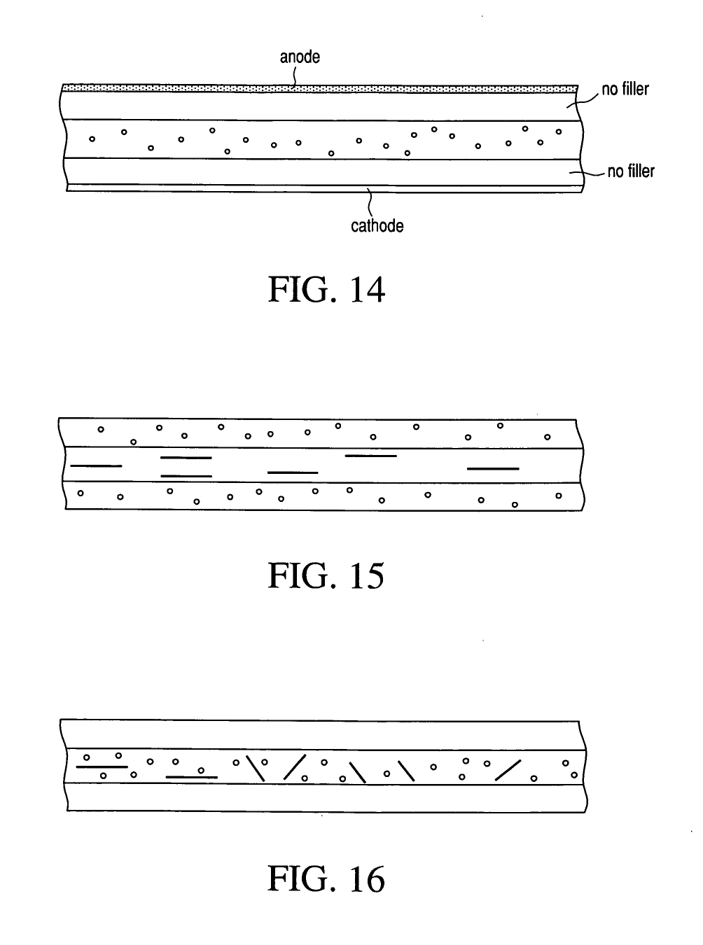

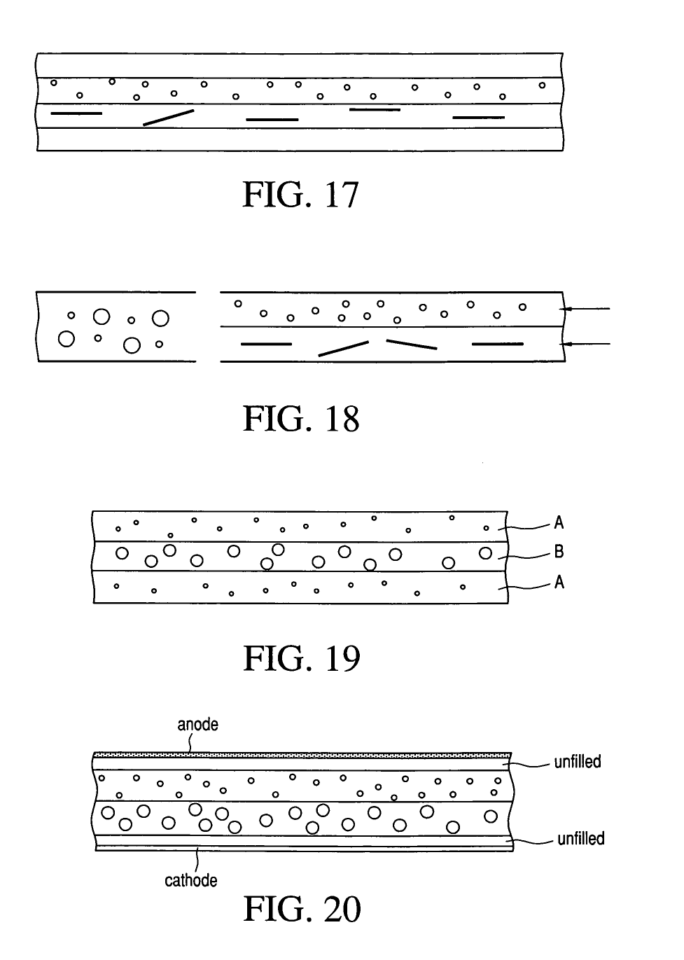

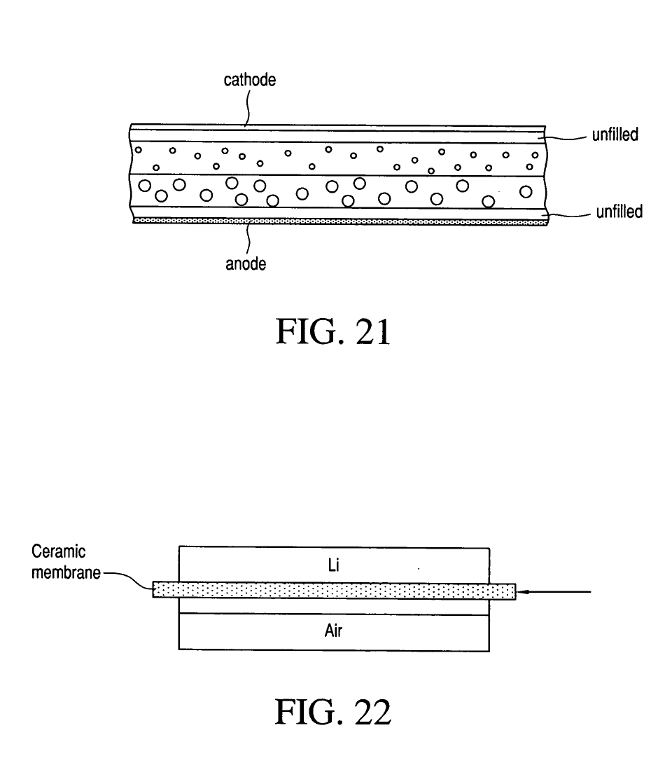

Redox active additives may be randomly distributed within a tape, may have spatially varying amounts within a tape, or may be present in varying sizes and shapes as shown in FIGS. 15 to 21. Tapes such as those for use in membranes that include redox active additives may be positioned parallel or perpendicular to an electrode such as an anode or cathode, and the redox active additives may be semi-continuously or discontinuously distributed in the tape. Also, embedded regions of redox active additives may be positioned parallel or perpendicular to a cathode or anode. In other aspects, such as shown in FIG. 14, unfilled air spaces may be present between a membrane and an electrode.

The tapes employed in embodiments such as shown in FIGS. 15-21 may be laminated into membranes to enable ionic conductivity across one or more layers of the membrane. Membranes may have a thickness of about 0.01 μm to about 1 mm, preferably about 0.1 μm to about 400 μm, most preferably about 1 μm to about 200 μm. Electrodes may be printed on to membranes by a variety of processes such as but not limited to screen printing.

Solid Oxide Fuel Cells that Employ Redox Active Additive Composite Electrolytes

In another embodiment, the invention relates to solid oxide fuel cells (SOFC) that employ a redox active additive composite electrolyte membrane. SOFCs that employ redox active additive composite ceramic electrolyte membranes may have higher efficiency, increased ionic current, longer-term stability, greater fuel flexibility, lower emissions, shorter start-up times, improved ionic diffusion kinetics, lower operating temperatures and improve reliability compared to SOFCs that employ conventional electrolytes. SOFCs that employ redox active additive composite electrolytes may enable operation at lower temperatures.

Electrolytes that may be employed in a redox active additive composite electrolyte membrane include but are not limited to ceramic electrolytes, polymeric electrolytes and combinations thereof. Ceramic electrolytes that may be employed include but are not limited to Y₂O₃—ZrO₂, Sc₂O₃—ZrO₂, Bi₂V₁₋ₓMeₓO_{5.5-x/2} where 0.05<x<0.3, Me is Cu, Ti, Zr, Ni, Al, Co, Mn, Ge, Zn, Mg, and mixtures thereof. Polymeric electrolytes that may be employed include but are not limited to Nafion and mixtures thereof.

Redox active additives that may employed in redox active additive composite electrolytes such as in a ceramic electrolyte is include but are not limited to MnO₂₋ₓ where 0<x<0.2, PbO, NiO_{1-y} where 0<y<0.1, CuO, V₂O_{5-z} where 0<z<0.5 and mixtures thereof. The amount of redox active additive in a ceramic electrolyte typically is about 25 wt. % based on the weight of the ceramic electrolyte. Where the SOFC is a protonic-based SOFC, the ceramic electrolyte may by a perovskite such as BaCeO₃, Y₂O₃-doped BaZrO₃ and mixtures thereof. Where the ceramic electrolyte is Y₂O₃-doped BaZrO₃, redox active additives that may be employed with the ceramic electrolytes include but are not limited to Ni, Pt, MnO₂₋ₓ where 0<x<0.2, RuO_{2-z} where 0<z<0.2, double layer hydroxides such as cobalt hydroxide, nickel aluminum hydroxide, cobalt aluminum hydroxide, cobalt chromium hydroxide, nickel chromium hydroxide or mixtures thereof.

Solid oxide fuel cells that employ Redox active composite electrolytes is further illustrated by the following non-limiting example:

### Example FC1

100 grams of yttria stabilized zirconia is mixed with 5 grams of MnO by ball milling in ethanol. The mixture is dried, crushed into powder and formed into ceramic discs by hydraulic compaction. The disks are fast fired in a 1700 C oven under reducing atmosphere for 20 mins. The sintered ceramic pellet is polished for use as an electrolyte in a solid oxide fuel cell after applying Pt electrodes on either side by firing an air dried Pt ink at 1200 C for 15 mins.

### Redox Active Additive Composite Polymer Electrolyte Membrane Fuel Cells (PEMFC)

In another embodiment, polymer electrolyte membrane fuel cells (PEMFC) that employ redox active additive composite polymeric electrolytes are disclosed. Redox active additive composite polymeric electrolytes employed in a PEMFC may enable operation of a fuel cell at about 220° C. or more to achieve improved efficiencies, improved energy densities, improved current, improved ease of cooling and reduced sensitivity to carbon monoxide poisoning of Pt catalyst. Polymer electrolytes that may be employed in redox active composite polymer electrolytes for use in membranes in PEMFCs include but are not limited to Nafion. Redox active additives that may be employed in the redox active additive composite polymeric electrolytes include but are not limited to MnO₂₋ₓ where 0<x<0.2 and RuO₂₋ₓ where 0<x<0.2, Ni and mixtures thereof. The redox active additives may be present in the composite electrolyte in an amount of about 0.1 wt. % to about 20 wt. % based on the weight of the polymeric electrolyte.

Ceramic Gas Separation Membranes that Employ Redox Active Additive Composite Electrolyte:

In another embodiment, membranes that employ redox active additive composite ceramic electrolytes such as for use in fluid separations such as gas separations are disclosed. These membranes may be employed at temperatures up to about 1200° C. and under temperature gradients of up to about 700° C. Operation at these temperatures and gradients may enable increased oxygen permeance relative to gas separation membranes that do not employ redox active additive composite electrolyte.

Ceramic electrolytes that may be employed in redox active additive composite ceramic gas separation membranes include but are not limited to Y₂O₃—ZrO₂, Sc₂O₃—ZrO₂, (La₁₋ₓCaₓ)_{y}FeO_{3-δ} where O<_{δ}<0.3, 0.5<x<1.0, and 1.0<y<1.1 and mixtures thereof. Redox active additives that may be employed in ceramic electrolytes include but are not limited to Ni, CeO2₋ₓ where 0<x<0.2, MnO_{2-y} where 0<y<0.2 and mixtures thereof. Redox additives may be present in the ceramic electrolyte in an amount of about 0.1 wt. % to about 50 wt. % based on weight of the ceramic electrolyte. The redox active additives may vary widely in morphologies. The redox active additives also may vary in size from about 1 nm to 1.0 μm. Redox active additives may be randomly distributed or have a graded distribution within the ceramic electrolyte.

Ceramic gas separation membranes that employ redox active ceramic electrolytes may be formed from multilayer laminates made by methods such as tape casting and extrusion. Electrodes may be joined to the ceramic membrane by co-firing or by post firing of electrode material onto the ceramic membrane as shown in US 20070237710, the teachings of which are incorporated by reference by their entirety herein.

Hydrogen Separation Membranes that Employ Redox Active Additive Composite Polymeric Proton Conductive Electrolytes

In another embodiment, hydrogen separation membranes that employ redox active additive proton conductive composite electrolytes are disclosed. These hydrogen separation membranes may be used to separate hydrogen from mixed gases at temperatures of about 20° C. to about 200° C.

Polymeric proton conductive electrolytes that may be employed with redox active additives the composite polymeric electrolytes include but are not limited to Nafion, sulfonated polybenzimidazoles, sulfonated polyether ether ketones, polyimides, polyphosphazenes and mixtures thereof. Sulfonated polybenzimidazoles that may be employed include but are not limited to poly(2,5-benzimidazole), phosphoric acid doped poly(2,2′-(1,3-phenylene)-5,5′-bibenzimidazole) and copolymers of PBI with sulfonated polysulfone, sulfonated polyether etherketones, pyridine based PBI and mixtures thereof; polyimides that may be employed include but are not limited to 3,3′-bis(sulfophenoxy)benzidine, 2,2′-bis(sulfophenoxy)benzidine, 3,3′-bis(sulfopropoxy)benzidine and, 2,2′-bis(sulfopropoxy)benzidine and mixtures thereof; polyphosphazenes that may be employed include but are not limited to imidazolyl, ethylamino, ethyl alanato, benzyl alanato, ethyl glycinato groups, and mixtures thereof.

Redox active additives that may be employed in redox active additive composite polymeric proton conductive electrolytes include but are not limited to RuO₂, MnO and mixtures thereof. Redox active additives may be included in the polymeric proton conductive electrolyte in an amount sufficient to improve ionic transport of protons across the membrane. Typically, the amount of redox active additive is present in the polymeric proton conductive electrolyte in an amount of about 5 wt. % to about 10 wt. % based on the weight of the polymer.

Hydrogen separation membranes that employ redox active additive composite polymeric proton conductive electrolytes may be made by forming a mixture of one or more polymeric proton conductive electrolytes and one or more redox active additives to form a mixture. The mixture then may cast into a membrane following the procedure of U.S. Pat. No. 4,664,761, the teachings of which are incorporated herein by reference in their entirety.

Electric Double Layer Capacitor (“EDLC”) Electrodes for Desalination and Purification of Water

In another embodiment, EDLC electrodes that utilize redox active additive composite electrolytes such as redox active additive composite polymeric electrolytes may be employed to desalinate water flowing through the electrodes. In this aspect, water flows through electrically charged, porous EDLC rod electrodes that include redox active additive composite electrolytes. The charged rods cause ions such as H⁺, Na⁺, Ca⁺, K⁺ in the water to migrate towards an EDLC rod electrode of opposite charge where the ions may be adsorbed onto the rod electrode. Voltage may be applied to the rods by various well known means such as solar cells, thermoelectric generators and combinations thereof. The EDLC rod electrodes may regenerate by turning off the applied voltage to enable release of adsorbed ions. Release of the adsorbed ions may be controlled to enable generation of an electrical current such as discharge of a capacitor or a battery.

Polymeric electrolytes that may be employed in the redox active composite polymeric electrolytes employed in the rods may include but are not limited to Nafion, polybenzimidazole, polyether ether ketone and combinations thereof. Redox active additives that may be employed include but are not limited to MoO₃. The redox active additives may be present in the polymeric electrolyte in an amount of about 0.1 wt. % to about 30 wt. % based on the weight of the polymeric electrolyte. To illustrate, PVDF (Mw=5.73×10⁵) and PMMA (Mw=1.04×10⁵) are mixed to provide a mixture of 25 wt % co-polymer blend and 75 wt % Sulfolane in order to form a polymer solution. The mixture is heated to 180 C in Nitrogen for 3 hours. Then, 10 wt % of layered double hydroxide (LDH) powder such as Co—Al; Ni—Al; Mn—Al; Zn—Al based on the weight of the mixture is added to the mixture. LDH powders are prepared by co-precipitating mixtures of respective nitrate solutions in NaOH solution using sodium carbonate as stabilizer. As prepared precipitate is refluxed at 60° C. for 18 h followed by washing and drying. The LDH powders are added and mixed in the polymer suspension for about 2 hours. Then, the polymer suspension is rapidly quenched to liquid nitrogen temperature, fractured, chopped and milled to grind the polymer into a powder. The polymer powder is compressed at about 10,000 to about 50,000 psi at about 180° C. in to monolithic composite sheets. These composite sheets are quenched into ice and then exposed to deionized water to extract the Sulfolane. After this the composite sheets are vacuum dried at 50° C. for 24 hours.

### Potentiometric Chemical Sensors

In another aspect, redox active additive composite electrolytes such as redox active additive composite glass electrolytes, redox active additive composite ceramic electrolytes and mixtures thereof may be employed in potentiometric chemical sensors such as oxygen sensors and pH sensors. Potentiometric chemical sensors that employ any one or more of redox active additive glass composite electrolytes and redox active additive ceramic composite electrolytes may show improved ability to detect trace amounts of gasses such as NO₂ in carbon monoxide, oxygen, nitrogen, sulfur dioxide and mixtures thereof. These sensors may show improved sensitivity to proton concentration and may enable increased voltage potential at a given concentration of protons compared to silver wire reference electrode.

Glass electrolytes that may be employed in redox active additive composite glass electrolytes potentiometric chemical sensors include but are not limited to glasses such as chalcogenide glasses, lithium doped borosilicate glasses and mixtures thereof. Chalcogenide glasses that may be employed include but are not limited to Mn doped As₂S₃, Ge₂₈Sb₁₂Se₆₀ and mixtures thereof. Lithium doped borosilicate glasses that may be employed include but are not limited to lithium-doped borosilicate glasses.

Where the potentiometric chemical sensor is a pH sensor, ceramic electrolytes that may be employed in redox active additive composite electrolytes include but are not limited to Y₂O₃ doped ZrO₂. Where the potentiometric chemical sensor is an oxygen sensor, ceramic electrolytes that may be employed in redox active additive composite electrolytes include but are not limited to Y₂O₃ doped ZrO₂, bismuth copper vanadium oxide and mixtures thereof.

Redox active additives that may be employed in any one or more of redox active additive composite ceramic electrolytes and redox active additive glass electrolytes include but are not limited to MoO₃, FeOₓ where 0<x<1.5, MnO_{y} where 0<y<1, NiO_{z} where 0<z<1.5, CuOₓ where 0<x<1.5, TiO_{y} where 0<y<2, FeO, Si, Pb, Ni, (La, Sr)(Mn, Co)O₃ and mixtures thereof. Redox active additives may be present in any one or more of glass electrolytes and ceramic electrolyte in amounts sufficient to cause enhancement in potential. Typically, these amounts are about 1 wt. % to about 30 wt. % based on the weight of the electrolyte.

### Membranes for Electro Membrane Extraction

In another embodiment, redox active additive composite polymeric electrolytes may be employed as membranes in electro-membrane extraction of ionic substances by application of an electric field as in electro-dialysis and electro-electrodialysis. Membranes that employ redox active additive composite polymeric electrolytes may be used in water desalination, wastewater treatments to recover heavy metals such as Au, Pt, Ag, Cu, Pd, Zn, Sn, Pb, Ni, Cd and mixtures thereof from electroplating baths, hydrometallurgy, paper and photography. Other applications include deacidification of proteins, amino acids, sugars etc. in food and pharmaceutical industry, removal of peptides and toxic/hormonal drug removal from water.

Polymeric electrolytes that may be employed in redox active additive composite electrolytes for use in membranes for electro membrane extraction include polyvinyl alcohol, polyacrylic acid, polybenzimidazole, polyether ether ketone and mixtures thereof.

Redox active additives that may be employed in redox active additive composite electrolytes for use in membranes for electro membrane extraction include but are not limited to MnO₂, layered double hydroxides (“LDH”) such as cobalt hydroxide, nickel aluminum hydroxide, cobalt aluminum hydroxide, cobalt chromium hydroxide, nickel chromium hydroxide, PbO₂ and mixtures thereof. The amount of redox active additive that may be employed in redox active additive composite electrolytes such as redox active additive composite polymeric electrolytes for use in membranes for electro membrane extraction is sufficient to cause enhanced separation rates. Typically, redox active additives are present in about 0.1 wt. % to about 25 wt. % based on the weight of the polymeric electrolyte.

Membranes for Electro membrane extraction may be made following procedures shown in U.S. Pat. No. 4,226,688, the teachings of which are incorporated herein by reference in their entirety. Membranes for Electro membrane extraction are further illustrated below by reference to the following non-limiting example:

### Example EM1

Mix 25 wt % PMMA (Mw=93300, Mn=46 400) from Scientific Polymer Products, and 75 wt % tert butyl alcohol (Reagent grade J.T.Baker Chemical Co) are mixed to form a solution. To this solution, WO_{3-d} powders (5 Wt %) which have been ball milled to an average particle size of 1 micron was added, and annealed in forming gas (5% H2, 95% N2) at 750 C for 3 hrs. The polymer solutions and suspensions are continuously stirred at 55 C for 120 min to maximize mixing of the filler particles. After this the mixture is quenched through cool water to room temperature within 1 minute and then cast onto a glass plate in order to form a membrane. The mixture then is put into a desiccator and a rotary vacuum pump is applied to remove the solvent. Subsequently, a process of replacing vacuum with argon gas and then re-evacuation is performed 5 times over a period of 2 hours to enable formation of micro porous PMMA membranes having redox inclusions of WO_{3-d}.

Electrochromic Devices that Employ Redox Active Additive Polymeric Electrolyte Composite Electrolyte

In another embodiment, electrochromic devices that include an anode, a cathode and redox active additive polymeric electrolyte composite electrolyte are disclosed. Electrochromic devices include electrochemical cells that change color during redox reactions at an electrode of the cells. Electrochromic behavior such as color change may be induced due to change in oxidation state of an anode material such as WO₃.

Electrochromic devices that employ redox active additive polymeric electrolytes may employ cathodes formed of conductive materials such as polyaniline, iridium oxide, vanadium oxide and mixtures thereof. Polymer electrolytes that may be employed include but are not limited to gel electrolytes such as PEO—H₃PO₄, gel mixtures such as PVDF-HFP/LiClO₄/EC/DMC and combinations thereof. Redox active additives that may be employed in redox active additive composite polymeric electrolytes include but are not limited to MoO₃, V₂O₅ and mixtures thereof. The amount of redox active additives may be about 1 wt. % to about 5 wt. % based on the weight of the polymeric electrolyte. However, where a gel electrolyte such as PEO—H₃PO₄ is employed, the amount of redox active additive in the gel electrolyte may be about 0.1 wt. % to about 10 wt. % based on the weight of the gel electrolyte. Electrochromic devices that utilize redox active additive composite polymer electrolytes may show improved electrochromic opacity such as occurs when an electrochromic devices changes between a colored, translucent state (usually blue) to a transparent state. Electrochromic devices that employ redox active additive polymeric electrolyte composite electrolyte may be made by methods such as those disclosed in U.S. Pat. Nos. 5,099,356 and 4,773,741, the teachings of which are incorporated herein by reference in their entirety.

Energy Storage Devices that Employ Redox Active Additive Composite Electrolyte Thin Films or Thick Films

Energy storage devices that employ thin films formed from redox active additive composite electrolytes may show much shorter diffusion lengths for ionic transport between electrodes that may enable a lowering of the natural time constant of the device and may enable an increase in power density. Thin films formed from redox active additive composite electrolytes may be employed in miniature energy storage devices for use in surface mount energy storage components. These miniature devices may include films of sub-micron thickness and may provide multiple on-board energy storage points within an electrical system and eliminate the need for use of a central, single energy source. These miniature devices may also provide backup power if a main power source were to fail.

Films that employ redox active additive composite electrolytes may be prepared by aerosol deposition and by sol-gel deposition, preferably aerosol deposition. The films may range in thickness of about 100 nm to about 300 microns. Aerosol deposition, as well as sol-gel deposition, may be used to form an assembly of thin film layers formed of redox active additive composite electrolytes. Energy storage devices that employ Redox active additive composite electrolyte thin films or thick films is further illustrated by reference to the following non-limiting example:

### Example CF1

Thin films of lithium Aluminum Germanium Phosphate (LAGP) composite with redox active phases having a thickness of about 10 nm to about 1 um are co-deposited using RF-sputtering/DC-sputtering techniques. The LAGP glass materials is cast in to a 2 inch diameter die in order to form transparent glass disks which are annealed at about 850 degree C. for about 2 hrs to about 4 hrs to form targets suitable for sputtering. Au is used as the redox active phase and is co-sputtered with LAGP in Ar atmosphere at about 10⁻⁶ Ton vacuum. The deposition rate of each component is controlled in order to obtain 95/5 volume ratio in order to produce films that may be annealed at about 30° C. to about 600 C for about 30 min to about 4 hrs in order to form composite electrolytes film.

Aerosol Deposited Ionic Conducting Composite Thin/Thick Film Electrolyte Composite with Redox Active Inclusions.

Thin films that typically have a thickness of about 100 nm to about 10 microns, as well as thick films that typically have a thickness of about 1 microns to about 300 microns, may be formed from a wide variety of redox active additive composite ionically conductive electrolytes by aerosol deposition. Ionically conducting electrolytes that may be employed include but are not limited to Na ion conducting electrolytes, Li ion conducting electrolytes, and mixtures thereof. Where Li ion conducting electrolytes are employed, Li ion conducting electrolytes such as Lithium lanthanum titanate (LLT) electrolyte, LAGP glass electrolyte, LiS-chalcogenide based glass electrolyte, and mixtures thereof may be mixed with one or more redox active additives and deposited by aerosol deposition to form lithium conducting electrolyte films that may have a thickness of about 1 micron to about 300 microns.

Li ion conducting electrolytes may be employed with redox active additives such as but not limited to MoO₃ particles for use in aerosol deposition. The relative amounts of Li conducting electrolyte and redox active additive may vary over a wide range to provide redox active additive composite electrolyte compositions suitable for use in aerosol deposition of films such as thin films and thick films.

As a non-limiting illustration, mixtures of about 1 wt. % to about 99 wt. % LLT powder, such as 95 wt. % LLT and about 1 wt. % to about 99 wt. % of MoO₃ such as 5 wt. % MoO₃, powder may be ball milled to form a blend that has an average particle size of about 100 nm to about 10 microns. Each of the LLT and MoO₃ powders may be freeze dried. Ball milling may be performed dry or in the presence of liquids such as Ethanol or propan-2-ol. The milled blend may be combined with a fluid such as water for use in aerosol deposition of MoO₃ redox active additive LLT composite electrolyte thin film and MoO₃ redox active additive LLT composite electrolyte thick film.

Aerosol deposition may be employed to deposit a thin film or thick film onto a substrate material such as a silicon wafer, stainless steel or another oxide. The substrate may be pre-coated with an electrode material. The electrode material may vary depending on the type of structure being formed. Where super-capacitor structures are being formed, suitable electrode materials may include but are not limited to Li blocking metals such as but not limited to Pt, Au, Ni, Ta, W, Al, Fe, high surface area carbons such as nanotubes, and mixtures thereof. Where battery structures are being formed, the electrode materials may include a redox active species such as a Li intercalation material such as but not limited to Si, LTO, LiCoO, LiMnO, and mixtures thereof. The compositions of the anode electrode and cathode electrode may be matched in a battery structure type device.

A composite electrode may be formed by aerosol deposition of two powders simultaneously, by either dual deposition fluxes or by a single flux of a premixed powder. The composite will comprise the ionically conducting species and the Li blocking material. The will generate a high surface area electrode material. The film coated substrate, in both electroded form and in non-electroded form, may be annealed over a wide range of temperatures in a variety of atmospheres under a range of pressures to improve crystallinity of the film and to improve interfacial bonding of the film to the substrate. Annealing may be performed under conditions of temperature, pressure, time and atmosphere to minimize diffusion from the film into the substrate. Where a redox active additive composite LTO electrolyte film such as a MoO₃ active additive LTO composite electrolyte film on a substrate such as stainless steel is being annealed, annealing may be performed at about 300° C. to about 600° C. for about 5 hrs to about 10 hrs under ambient air atmosphere at a pressure of about 0.01 to about 16 PSI.

An electrochemical energy storage device such as a battery or super-capacitor may employ an anode of deposited Li metal such as by evaporation to provide a reversible Li source. The Li metal electrode may be protected by a protective overlayer of an epoxy or polymer such as polypropylene or Teflon to protect the Lithium against oxidation. Electrical contact to the Lithium electrode may be provided through a contact metal such as Ag, Al, alloys thereof and mixtures thereof. The contact metal is applied to the electrode prior to application of a protective overlayer. Aerosol deposited ionic conducting composite thin/thick film electrolyte composite with redox active inclusions is further illustrated by reference to the following non-limiting example:

### Example AF1

Films with a thickness of about 100 nm to about 10 um are fabricated via aerosol deposition. Fine powders (about 100 nm-about 900 nm) of Lithium Aluminum Germanium Phosphate and Tin Oxide are deposited by aerosol deposition onto Pt or carbon substrates in order to produce film. The film is post annealed at about 500 C to about 800 C for about 30 min-about 2 hrs in order to form electrolyte.

### Sol-Gel Deposited Composite Li Conducting Thin Film Electrolyte.

A MoO₃ redox active additive Lithium Lanthanum Titanate (LLT) composite electrolyte may be produced by use of sol gel procedures. By use of sol-gel, nanosize MoO₃ particles that vary from about 10 nm to about 500 nm in size are dispersed in a LLT precursor solution of lithium ethoxide, titanium isopropoxide, and lanthanum isopropoxide dissolved in 2-methoxyethanol to enable formation of a sol.

Stoichiometric quantities of lithium ethoxide, titanium isopropoxide, lanthanum isopropoxide and 2-methoxyethanol are partially hydrolyzed using DI H₂O to from a precursor solution. The MoO₃ particles are added to the precursor solution in a ratio of about 5% wt to about 50% wt. relative to the amount of LLT and stirred vigorously to disperse the MoO₃ particles to produce a MoO₃ active additive LLT electrolyte composite precursor solution. The composite precursor solution may be used to prepare a sol-gel film by methods such as dip coating and spin coating on to a suitable substrate such as Pt coated Si wafer. Regardless of where dip coating or spin coating is employed, the deposited first layer may be pyrolyzed at 400° C. such as in a rapid thermal annealing furnace. Additional layers then may be deposited onto the pyrolyzed layer and pyrolyzed to build a desired film thickness. After a desired thickness of film is achieved, the film may be heat treated such as at about 700° C. for about 6 hours in an oxidizing atmosphere.

### Sputtered Redox Active Additive Composite Electrolyte Thin Film

Thin films of redox active composite electrolytes also may be prepared by sputtering where two or more sputtering targets are employed. A first sputtering target is an ionically conductive electrolyte such as but not limited to LLT. Another sputtering target is a redox active additive material such as but not limited to LiCoO₂.

Sputtering deposition of a thin and thick film may be performed by alternating sputtering targets to produce a chemically heterogeneous film of redox active additive composite electrolyte. Typical film thickness may range from 10 nm to 2 μm. The sputtering temperature is sufficient to mitigate significant interdiffusion. Sputtering temperatures that may be employed vary from about 100 C to about 800 C. Where the redox active additive is being sputtered, the time duration of sputtering of the redox active additive may be pulsed. This may generate a various chemical distributions varying from discrete islands to continuous layers.

Thin films of redox active composite electrolytes also may be prepared by sputtering a unitary composite target that includes a conductive glass ceramic electrolyte such as but not limited to LAGP and a redox active additive such as but not limited to Au to produce a homogenous film. Where LAGP is employed, Au may be used as a redox active additive such as in an amount of about 5% wt Au based on the weight of the LAGP. The deposited film may be annealed at a suitable temperature to precipitate the redox active additive within the electrolyte whereby the redox active additive may function as a redox active center. Where Au is employed with LAGP, annealing may be performed at about 800° C. to enable precipitation of Au within the LAGP glass ceramic matrix to enable Au to function as a redox active center.

1. An ionically conducting, redox active additive composite electrolyte comprising an ionically conductive component and a redox active additive wherein the ionically conductive component is selected from the group consisting of ionically conductive polymer, ionically conducting glass-ceramic, ionically conductive ceramic, and mixtures thereof.

2. A capacitor comprising an anode, a cathode and an ionically conducting, redox active additive composite electrolyte comprising an ionically conductive polymer and a redox active additive wherein the ionically conductive component is selected from the group consisting of ionically conductive polymer, ionically conducting glass-ceramic, ionically conductive ceramic, and mixtures thereof.

3. A primary battery comprising an anode, a cathode and an ionically conducting, redox active additive composite electrolyte comprising an ionically conductive polymer and a redox active additive wherein the ionically conductive component is selected from the group consisting of ionically conductive polymer, ionically conducting glass-ceramic, ionically conductive ceramic, and mixtures thereof.

4. A secondary battery comprising an anode, a cathode and an ionically conducting, redox active additive composite electrolyte comprising an ionically conductive polymer and a redox active additive wherein the ionically conductive component is selected from the group consisting of ionically conductive polymer, ionically conducting glass-ceramic, ionically conductive ceramic, and mixtures thereof.

5. The electrolyte of claim 1 wherein the ionically conductive polymer is a polymer selected from the group consisting of PVDF, PVDF-HFP, PVDF-TFE, PVDF-CTFE, PVDF-TrFE mixtures thereof.

6. The electrolyte of claim 1 wherein the ionically conducting polymer is selected from the group consisting of Ag⁺ conducting polymers, H⁺ conducting polymers, OH— conducting membranes Li⁺ conducting polymers, Mg⁺ conducting polymers, Na⁺ conducting polymers, O⁻ conducting polymers and mixtures thereof.

7. The electrolyte of claim 5 wherein redox active additives are selected from the group consisting of redox active oxides, redox active metals and mixtures thereof.

8. The electrolyte of claim 5 wherein the polymer is a Li+ polymer and the redox active additives are selected from the group consisting of MoO₃, SnO₂, WO₃, PbO, ZnO, Fe₂O₃, Cr₂O₃, V₂O₅, MnO₂, LiTiO₃ and mixtures thereof.

9. An ionically conducting polymer, redox active oxide composite electrolyte comprising Li+ conducting PVDF-HFP Polymer and a redox active additive selected from the group consisting of MoO₃, SNO₂, Pt, and mixtures thereof.

10. A cell comprising an ionically conducting polymer, redox active oxide composite electrolyte comprising Li+ conducting PVDF-HFP polymer and a redox active additive selected from the group consisting of MoO₃, SNO₂, Pt, and mixtures thereof, an activated carbon cathode, lithium metal anode, and a carbon paper current collector.

11. An ionically conducting glass-ceramic, redox additive composite electrolyte comprising an ionically conducting glass-ceramic and a redox additive wherein the ionically conducting glass-ceramic is selected from the group consisting of chalcogenide glass-ceramics, fluoride glass-ceramics, oxide glass-ceramics, phosphate glass-ceramic, sulfide glass-ceramic and mixtures thereof.

12. The electrolyte of claim 11 wherein the redox active additive is selected from the group consisting of redox active metals, redox active oxides, redox active oxynitrides and mixtures thereof.

13. The electrolyte of claim 11 wherein the redox active additive is a redox active metal selected from the group consisting of Au, Pt, Pd, Sn, Al, Fe, Sb, Cu—Sn alloys, Cu—Sb alloys, Si, alloys thereof and mixtures thereof.

14. The electrolyte of claim 11 wherein the redox active additive is a redox active oxide selected from the group consisting of antimony oxide, barium oxide, bismuth oxide, boron oxide, calcium oxide, chromium oxide, cobalt oxide, copper oxide, germanium oxide, indium oxide, iron oxide, lead oxide, lithium cobalt oxide, lithium oxide, lithium titanate, lithium iron phosphorous oxide, iron phosphorous oxide, phosphorous oxide, lithium vanadium oxide, manganese oxide, molybdenum oxide, niobium oxide, silver oxide, tin oxide, titanium oxide, tungsten oxide, vanadium oxide, zinc oxide and mixtures thereof.

15. The electrolyte of claim 11 wherein the redox active additive is a redox active oxynitride.

16. An electrochemical capacitor comprising an anode, a cathode and the electrolyte of claim 1.

17. A solid state battery comprising a composite ionically conductive polymer-redox active additive electrolyte body, a cathode layer joined to a surface of the electrolyte body wherein the cathode layer comprises an electrode active substance and the composite electrolyte, an anode layer joined to a surface of the composite electrolyte wherein the anode comprises an electrode active substance and the composite electrolyte, a first collector electrode electrically connected to the cathode layer, and a second collector electrode electrically connected to the anode layer.

18. A fuel cell comprising an anode, a cathode, an ionically conductive composite electrolyte comprising an ionically conducting polymer having a redox active additive therein, and a fluid oxidant.

19. A fuel cell comprising an anode, a cathode, an ionically conductive composite electrolyte comprising an ionically conducting ceramic and having a redox active additive.

20. A membrane suitable for use in a hybrid capacitor or battery wherein the membrane comprises an anode, a cathode and redox active additive composite electrolyte wherein the membrane includes separated regions that function as a battery or a capacitor.

21. A Li-air battery comprising a Li anode, an air cathode and a redox active additive composite electrolyte wherein the composite electrolyte comprises an ionically conductive glass ceramic and a redox active additive.

22. A Mg-air battery comprising an Mg anode, an air cathode and an ionically conducting, redox active additive composite electrolyte.

23. A membrane suitable for use in electro-membrane extraction of ionic substances comprising an ionically conducting, redox active additive composite electrolyte wherein the composite electrolyte comprise an ionically conductive polymer and a redox active additive.

24. A potentiometric chemical sensor wherein the improvement comprises a membrane comprising an ionically conducting, redox active additive composite electrolyte wherein the composite electrolyte comprises an ionically conductive component and a redox active additive wherein the ionically conductive component is selected from the group consisting of ionically conductive glass ceramic, ionically conducting ceramic, ionically conducting polymer and mixtures thereof.

25. Electrochromic display membrane comprising an anode, a cathode and an ionically conducting, redox active additive composite electrolyte comprising an ionically conductive component polymer and a redox active additive wherein the ionically conductive component is selected from the group consisting of ionically conductive polymer, ionically conductive glass ceramic, and mixtures thereof.

26. A water desalination membrane comprising an ionically conducting, redox active additive composite electrolyte wherein the composite electrolyte comprise an ionically conductive polymer and a redox active additive.
